(19) United States
(12) Patent Application Publication
(10) Pub. No.: US 2026/0195828 A1
(43) Pub. Date: Jul. 9, 2026

(54) HYDROGEN PRODUCTION AND DISTRIBUTION SYSTEM

(71) Applicant: Everfuel Europe A/S, Herning (DK)

(72) Inventors: Jacob Bech KROGSGAARD, Holstebro (DK); Uffe Vikøren BORUP, Sydals (DK); Sondre TORP, Åbyhøj (DK); Sanjeet Kumar DWIVEDI, Kolding (DK)

(21) Appl. No.: 19/133,006

(22) PCT Filed: Nov. 24, 2023
(86) PCT No.: PCT/DK2023/050282

§ 371 Date: May 27, 2025

(30) Foreign Application Priority Data
Nov. 24, 2022 (DK) PA202270573

(51) Int. Cl. G06Q 50/06; C25B 1/02; C25B 15/02

(52) U.S. Cl. CPC G06Q 50/06; C25B 1/02; C25B 15/02

(57) ABSTRACT

The invention relates to a system configured to distribute hydrogen in a hydrogen infrastructure system. A system controller is configured for receiving data from a part infrastructure members and based on the received data, the system controller is able to control storage of produced hydrogen in a stationary hydrogen storage or mobile hydrogen storage, categorize the stored hydrogen, allow a plurality of industrial consumers to request a quantity of hydrogen, matching a request from a particular industrial consumer with said produced hydrogen, and if a match can be established facilitate delivery of said requested quantity of hydrogen to the particular industrial costumer.

### FIELD OF THE INVENTION

The invention relates to a system for managing and distributing hydrogen in a hydrogen infrastructure and to a control method hereof.

### BACKGROUND OF THE INVENTION

In the art several document relating to hydrogen production is known. One of these documents is EP1177154 which discloses an energy distribution network for providing hydrogen fuel to a user comprising. Energy resource and hydrogen production means are connected by supply means to control hydrogen production means.

Further document EP3896816 discloses a hydrogen-energy control system including a hydrogen energy system, a power grid control system, a hydrogen transport system, and a hydrogen-energy integrated management system configured to control the hydrogen energy system based on communication with the power grid control system. The hydrogen-energy integrated management system is configured to perform communication related to charge and discharge requests with the power grid control system and related to hydrogen demand with the hydrogen transport system. A target hydrogen-production amount and an operation plan in the hydrogen energy system is determined.

Further document EP1719235 discloses an energy network. An embodiment includes a network having a plurality of power stations and a plurality electrolysers. The network also includes a controller that is connected to both the stations and the electrolysers. The controller is operable to vary the available power from the power stations and/or adjust the demand from the electrolysers to provide a desired match of availability with demand and produce hydrogen as a transportation fuel with specific verifiable emission characteristics.

Further document EP3950575 disclose an apparatus for generating an operation plan of a hydrogen production system. A hydrogen production apparatus, comprising: a demand predicting unit for generating a predicted demand amount for each of a plurality of types of hydrogen with a different environmental load of production over a target period; and an operation planning unit for generating the plurality of types of hydrogen, based on a predicted hydrogen demand amount of each of the plurality of types of hydrogen.

Accordingly from the prior art, it is known to produce hydrogen of different types and plan production of hydrogen to match a predicted demand of hydrogen. One 10 problem not considered in the art, is how to manage a plurality of real-time requests from different hydrogen consumers on a limited hydrogen resource.

### SUMMARY OF THE INVENTION

The inventors have identified the above-mentioned problem and challenge related to manage several requests on the same quantity of hydrogen, determine which consumer should have this quantity and plan distribution of this quantity in a hydrogen infrastructure.

In an aspect, the invention relates to a system configured to allocate and distribute hydrogen in a hydrogen infrastructure system, wherein said hydrogen infrastructure system comprises a plurality of infrastructure members including: an electrolyser configured for producing hydrogen, a stationary hydrogen storage, a plurality of mobile hydrogen storage, and a plurality of industrial consumers, wherein a system controller is configured for receiving data from at least part of said infrastructure members and based on said received data, said system controller is configured for: manage quantity of currently available hydrogen of said hydrogen infrastructure system and of future available hydrogen in said hydrogen infrastructure system, allow a plurality of industrial consumers to request a quantity of hydrogen wherein said request include at least one request requirement, matching a request requirement from a request from a particular industrial consumer with any combination of said currently available hydrogen and said future available hydrogen, and if a match can be established facilitate delivery of said requested quantity of hydrogen to said particular industrial costumer.

The system is advantageous in that it provides an industrial consumer the possibility to receive hydrogen as alternative to an existing gas supply. Such existing gas supply is typically a Methane gas supplied via a hydrogen transmission line such as a pipeline. The hydrogen can be delivered according to requirements of the request via mobile trailers i.e., without the need of establishing a hydrogen pipeline. Hence a flexible supply of costumer defined hydrogen (price, time of delivery, colour, liquid/gaseous delivery, etc.) is made available by the present system.

Further, the system is advantages in that the industrial consumer is able to coordinate its environmental social government by acquire hydrogen of a particular category. Such as if the industrial consumer is obligated or required to use a certain mix of hydrogen categories, this can be accomplished by placing one or more requests for a quantity of hydrogen of a specific hydrogen category in the present system. In this way, the consumer is able to control compensation of e.g., Carbon Dioxide emission.

Further, the system is advantageous to the hydrogen system operator in that hydrogen production can be optimized. More specific the production of different categories of hydrogen can be aligned with request of such categories. This has the effect, that pricing of hydrogen (available or to be produced) in the infrastructure can be brought down to the benefit of all stakeholders of the infrastructure and the environment. Optimized hydrogen production may include utilisation of the individual electrolysers in the infrastructure (increase/decrease of production), planning of production close to consumers, planning of transportation, etc.

Hydrogen infrastructure system should be understood as the elements needed to produce and distribute hydrogen in either a liquid or a gaseous form. Storage, pipeline, trailers and docking for trailers may be referred as the actual hydrogen infrastructure whereas when including power production, electrolyser and consumer a reference to a hydrogen infrastructure system is appropriate.

The infrastructure is a gaseous hydrogen infrastructure, but could in principle also be a liquid hydrogen infrastructure if appropriate equipment for handling cryogenic cooling and transport is implemented.

The electrolyser may be based on various principles such as atmospheric or pressurized alkaline, Polymer Electrolyte Membrane and solid oxide electrolyser cells. As the way of producing hydrogen is not essential to the present invention, the electrolyser is not described in further details.

A stationary hydrogen storage (also referred to simply as stationary storage) should be understood as one or more storage vessels such as cylinders. Such storage may be transportable, but intended to maintain stationary when first mounted to a flow line to the electrolyser. Flow of hydrogen from the electrolyser to the stational storage may be directly or via a compressor to increase pressure in the stationary storage and thereby be able to increase storage capacity.

A mobile hydrogen storage (also referred to simply as a mobile storage) should be understood as a trailer having one or more storage vessels. The principles of the stationary and mobile storages are the same, only with the difference that the mobile storage can easily be moved from one location to another. One example of a mobile storage is a tube trailer, another is a trailer on which racks of vessels can be lifted on and off.

Industrial consumers (sometimes referred to simply as consumer) should be understood as enterprises using e.g., a heating process where gas is used as source for heating in production. Such consumer may have a burner for burning gas such as hydrogen or Methane or a variable burner which facilitates using both types of gas as heat source. Alternatively, an industrial consumer may be a hydrogen refueling station for filling vehicles, trailers, ships, airplanes and other means of transportation. Alternatively, an industrial consumer may be a group of consumers that as a group is consuming hydrogen as an example could be mentioned a group of private owners of a hydrogen fuel cell vehicle. Industrial processes using hydrogen may include: refining petroleum, producing ammonia, metal processing, food industry (hydrogenation of fats and oils), chemical production (hydrogen as a key reactant), electronics and glass manufacturing (hydrogen may be used as a carrier gas for semiconductor manufacturing)

The system controller should be understood as a central controller. By central should be understood configured for communicating with a plurality of the elements of comprised by the hydrogen infrastructure system. The system controller may be cloud based or locally anchored e.g., at the site of an operator of the system.

An operator of the system should be understood as a user specifying threshold for production or non-production of hydrogen in terms of price, request, colour etc. and thus is responsible for hydrogen production and delivery of hydrogen to the consumers.

The system controller facilitates bi-directional communication with the elements of the hydrogen infrastructure system. Such communication to the system controller may include measurements of flow, pressure, temperature, etc. Further, such communication to the system controller may include information about present and future weather, present and future energy prices, present and future energy production at various power generation sites, etc. Further such communication to the system controller may include information of requests from consumers, location of mobile storage, State of Charge of mobile storage, etc. Further such communication from the system controller may include start and stop commands, destination for mobile storage, etc. The above examples of information communicated between elements of the hydrogen infrastructure and the system controller are non-limiting examples of information that can be communicated therebetween.

A quantity of hydrogen should be understood as a volume of hydrogen such as a batch or part of a batch of produced hydrogen. A quantity of hydrogen may be defined by the consumer via the request such as a given volume of hydrogen having a certified colour, price, delivery date, etc.

According to an embodiment of the invention, said system controller is configured for transmitting a start production of hydrogen setpoint to said electrolyser prior to receiving said request.

This is advantageous in that it has the effect, that hydrogen can be produced e.g., when energy prices are low, when storage capacity is available, when future energy prices are expected to increase, before request for hydrogen is expected to increase, when renewable power is available to produce green hydrogen, etc.

According to an embodiment of the invention, said system controller is configured for transmitting a start producing said hydrogen setpoint to said electrolyser based on request requirements comprised by said request.

This is advantageous in that it allows the controller to time production of hydrogen with consumer request. In this way, hydrogen can be produced on request and not for stock i.e., the storage capacity in the hydrogen infrastructure can be reduced. A further advantage is that this allow for slower technologies to be integrated in the system. As a non-limiting example of such slow process may be hydrocracking for producing fossil fuel. In this process it is import that hydrogen is available when needed and thus, delivery time/offtake may be change depending on how the process progresses.

According to an embodiment of the invention, said system controller is configured to categorize said produce hydrogen in batches.

A batch of hydrogen should be understood as one or more quantities of hydrogen. Hence a batch of hydrogen may be hydrogen produced in a given time slot, based on a specific type of power supplied to the electrolyser, etc.

According to an embodiment of the invention, a batch of hydrogen is defined as a quantity of hydrogen produced based on a particular type of power.

This is advantageous in that it has the effect, that according to type of power supplied to the electrolyser during production of the batch of hydrogen/the production method, the batch can be certified. One principle according to which a hydrogen batch can be categorised/certified is according to emission of Carbon Dioxide during production. Hydrogen categorized as grey releases more Carbon Dioxide than other categories, blue is focused on taking out over 80% of the Carbon Dioxide emissions whereas green hydrogen is eliminating Carbon Dioxide emissions. Hence, based on the Carbon Dioxide emission such as from power used to produce a batch of hydrogen, a batch can be certified as green (produced by wind turbine, photovoltaic and other renewals), yellow (100% produced by photovoltaics), brown (produced by fossil generated power), pink (produced by nuclear power), blue (produced from natural gas sources like methane through Auto Thermal Reforming and Steam Methane

Reforming), etc. A batch may also include a mix of such colours of hydrogen. Thereby a colour of hydrogen defined batch may be one requirement of an industrial consumer request. Note, that a batch of hydrogen may also be defined prior to production of the hydrogen based on expected power supply, quantity, etc. Such batch may also be referred to as a expected or assumed batch.

A certification of a batch or quantity of hydrogen may be based on a variety information related to the specific batch/quantity. This information may include source of power supply to hydrogen production, physical location of power source and electrolyser (transmission of power), storage of hydrogen, transport of hydrogen such as energy used for transport, time of production, energy used to produce a given batch, thermal efficiency of electrolyser (an old electrolyser may use more power/produce more heat than a new electrolyser to produce a given amount of hydrogen), use of excess heat in district heating or similar, purity of the produced hydrogen, etc. the transportation may contribute differently depending on if a pipeline, electric vehicle, fuel cell vehicle, fossil fuel vehicle, etc is used for transportation.

According to an embodiment of the invention, a batch is defined as a quantity of hydrogen produced during a particular period of time.

This is advantageous in that it has the effect, that cost of production of such batch may be reduced and thereby a timely defined batch may be one requirement of an industrial consumer request or may be part of the hydrogen delivery package.

According to an embodiment of the invention, a batch is defined after the hydrogen comprised by the batch is produced.

An electrolyser may produce a quantity of 10.000 kg hydrogen during 24 hours and store this in one storage. When produced, 2.300 kg may be brown, 4.700 kg may be green and 3.000 kg may not be possible to categorize with sufficient certainty to label it green hydrogen. If a costumer then request a quantity of 1.500 kg of green hydrogen, the system controller then deliver 1.500 kg hydrogen from the single storage and reduce the total amount with 1.500 kg, more particular the amount of green hydrogen is reduced by 1.500 kg. So the storage subsequently comprise 8.500 kg of which 2.300 kg is brown, 3.200 kg is green and 3.000 kg is uncategorized.

In fact, the category of at least part of the hydrogen of a batch may change prior to it being sold/offered for sale. By changing category of a quantity e.g., from brown to green may increase its value. If such change of category is made, the category of a similar quantity of hydrogen stored elsewhere in the infrastructure is changed from green to brown. In this way the amount of hydrogen of a specific category is maintained in the infrastructure.

According to an embodiment of the invention, said batch of hydrogen is a mix of currently available hydrogen and future available hydrogen.

According to an embodiment of the invention, said quantity of hydrogen is defined by at least one industrial consumer selectable requirement of the list comprising: volume, price, colour, time of delivery, time of production, purity, means of transportation and electrolyser power source.

Being able to provide a request for a consumer selectable quantity of hydrogen is advantageous in that it has the effect, that the consumer is able to plane delivery of hydrogen. Such planning may include colour of hydrogen (i.e. type of power used to produce it) and thereby carbon dioxide footprint, hydrogen based production slot, cost estimations, etc.

According to an embodiment of the invention, said system controller is configured for determining a colour of said quantity of hydrogen of said produced hydrogen according to the type of power supplied to said electrolyser during production of said quantity of hydrogen.

It should be mentioned that the colouring of hydrogen refers to a quantity or batch of hydrogen that can be certified as either green (produced based on power from a renewal power generator), brown (produced based on power from a fossil fuel-based power generator), pink (produced based on power from a nuclear plant), etc.

According to an embodiment of the invention, hydrogen in at least one of said batches is a mix of hydrogen quantities having different colours.

A particular hydrogen storage cylinder may in total comprise 200 kg of hydrogen. When completely full, then 150 kg hydrogen may be certified green hydrogen (i.e., documented produced based on renewable power) and 50 kg hydrogen may e.g., be uncertifiable or brown hydrogen. Hence a quantity of hydrogen from such batch may either be green (if less than 150 kg), brown (if less than 50 kg) or a mix of green and brown hydrogen.

According to an embodiment of the invention, hydrogen in at least one of said batches is a green hydrogen quantity.

The flow of produced hydrogen from the electrolyser may be controlled so that hydrogen produced based on renewable power is filling a hydrogen storage cylinder or trailer completely.

According to an embodiment of the invention, said hydrogen infrastructure system comprise a gas supply line and a hydrogen transmission line.

This is advantageous in that it has the effect, that the consumer is able to switch between using the hydrogen and the gas available in the gas supply line (e.g. natural gas such as Methane) according to availability, price, etc. Hence one of or a combination of the gas of the gas supply line and hydrogen may be used as supply for a baseload and the other may be used e.g., if the price is lower, colour of gas is as desired, etc. The hydrogen transmission line is part of a hydrogen supply network which may include mobile transportation of hydrogen.

According to an embodiment of the invention, said hydrogen transmission line connecting said electrolyser with said stationary hydrogen storage.

According to an embodiment of the invention, said hydrogen transmission line furthermore connects said stationary hydrogen storage with said industrial consumers.

According to an embodiment of the invention, said hydrogen transmission line furthermore connects said electrolyser with said mobile hydrogen storage.

Such hydrogen infrastructure system is advantageous in that the hydrogen value chain is made flexible so as to fit to the inherent flexibility of renewable energy production. Hence, hydrogen can be produced when desired type of power is available and stored in a buffer for later use or transmitted via pipes or trailers to an industrial consumer that has placed a request for hydrogen.

The mobile hydrogen storage is especially advantageous in areas where the hydrogen infrastructure is not fully built with hydrogen transmission line. In such area, hydrogen gas may be delivered via tube trailer (an example of a mobile hydrogen storage).

According to an embodiment of the invention, power is supplied to said electrolyser from at least one power plant selected from the list power plants comprising: nuclear, wind power plant, solar power plant, nuclear power plant, coal-based power plant, biomass-based power plant, Methane based power plant.

According to an embodiment of the invention, said industrial consumer comprises an onsite buffer, preferably a mobile hydrogen storage.

Having means for connecting a mobile hydrogen storage to an onsite transmission line is advantageous in that the size of the onsite storage is flexible in terms of volume that can be stored onsite.

According to an embodiment of the invention, said industrial consumer comprises a mobile hydrogen storage connection.

A mobile hydrogen storage connection is advantageous in that it enables the industrial consumer to be supplied with gas such as hydrogen gas from a hydrogen storage trailer. In this way, the industrial consumer is able to have a trailer storage parked and use this either as main gas supply or as reserve supply to another main gas supply. Further, if the mobile hydrogen storage connection enables connection of several trailers the flexibility is increased and thus the industrial consumer is able to be more flexible in requirements of a request for a quantity of hydrogen.

According to an embodiment of the invention, said industrial consumer comprises a gas supply line.

A gas supply line for feeding gas to a consumer is advantageous in that energy security is increased. Such gas supply line may furthermore be advantageous in that it may supply e.g., a methane gas, a hydrogen gas, or a mix thereof to the consumer.

According to an embodiment of the invention, said industrial consumers has a variable gas burner.

A variable burner adds flexibility to the industrial consumer e.g., allowing the consumer to use hydrogen when this is cheaper than e.g., methane and vice versa or even a mix of these two types of gas.

According to an embodiment of the invention, said request of said quantity of hydrogen include at least one request requirement selected from the list of requirements comprising: weight, colour, time of delivery and delivery method.

The time of delivery is advantageous in that the longer time, the operator of the electrolysis has to produce the hydrogen, the better chance for a lower production cost and thereby cheaper hydrogen. This is in contrary to a time of delivery with a short timeline, then hydrogen need to be produced no matter cost of production leading to an increased price of hydrogen.

The delivery method is advantageous in that if delivery by transmission line (such as a pipeline if available) is required, instant delivery may be possible whereas if delivery by trailer is required, delivery depend on availability of trailers.

The colour is as mentioned advantageous if a green profile is required by the consumer.

According to an embodiment of the invention, said system controller is configured for sorting a plurality of said requests according to said request requirements.

Sorting requests is advantageous in that the system controller then is able to prioritize which request to confirm and deliver/confirm first if not all requests can be confirmed and delivered at the same time. This may be the case if the volume of available hydrogen e.g., of a particular category is limited or if the number of available tube trailers is limited.

The invention relates to a system described in the paragraphs [0068]-[0155] implemented in a system described in the paragraphs [008]-[0066].

Moreover in an aspect, the invention relates to a method of distributing hydrogen in a hydrogen infrastructure system comprising: an electrolyser for production of hydrogen, a stationary hydrogen storage, a plurality of mobile hydrogen storage, a plurality of distributed industrial consumers comprising a consumer user interface and a local controller, and a system controller, wherein at least one of said distributed industrial consumers: via said consumer user interface and said local controller establish a request for hydrogen defined by at least one request requirement wherein said at least one request requirement specifies at least quantity of requested hydrogen and time of delivery of said hydrogen, and wherein said request is transmitted to said system controller, wherein said system controller is matching said request with any combination of current available hydrogen and future available hydrogen, wherein said future available hydrogen is available in time for delivery to said distributed industrial consumer within said time of delivery, and

wherein said system controller is performing a continuous re-matching of said request with current available hydrogen and future available hydrogen to determine the most cost-efficient combination of hydrogen which is complying with said request.

The method is advantageous in that it has the effect, that an industrial consumer is able to request a particular quantity of gaseous hydrogen that is customized to the needs of the consumer. Such needs may e.g., relate to Carbon Dioxide emission of the consumer, urgency in delivery, price, etc.

A power supply operator should be understood as a person, company or system that is operating a power generation plant or controlling a power transmission grid or distribution grid and the like. By operation should be understood managing production capacity which in a non-limiting example could be if a wind turbine or wind power park should produce at nominal or derated capacity.

By communicating with one or more power supply operators, it is possible for the system controller to obtain information of capacity, price, etc. of various types of power. Thereby the system controller is able to plan the most optimal power source for the electrolyser in terms of e.g., price or type of power.

A batch of produced hydrogen should be understood as an identifiable volume of produced hydrogen. A batch of hydrogen may be defined by the timeslot it was produced, the type of power supplied to the electrolyser during production, price range of power used by the electrolyser to produce hydrogen, etc.

The further available hydrogen need to be produced so that it can be delivered at the industrial consumer within said time of delivery.

The continuous re-matching should be understood as a real-time update of price of available and future available hydrogen.

The most cost-efficient combination of available hydrogen and future available hydrogen may be determined based on a plurality of different parameters such as cost of production, cost of transportation, availability of means of transportation (such as truck trailer), etc. Hence, hydrogen on stock may be more expensive than producing new hydrogen, however with respect to future production and logistics planning, it may be most cost effective to match a request with a quantity of such “expensive” hydrogen on stock because it would be more expensive in the future not being able to store or transport produced hydrogen.

This match is continuous updated by the system controller based on input from various members of the hydrogen infrastructure illustrated in FIG. 3, more specific from sensors or controllers of such members.

Time of delivery may include at least as soon as possible, to be determined, not important or a specific date with or without a time of the day. The more flexibility in time of delivery (and in other elements of a hydrogen delivery), the more flexibility, is provided to the system controller when composing the best hydrogen delivery package (including time of delivery, delivery method, origin and type of hydrogen, price, quantity, etc.) to the costumer.

According to an embodiment of the invention, said system controller is transmitting a start of production of hydrogen setpoint to said electrolyser at least every 30 minutes, preferably at least every 15 minutes, most preferably at least every 5 minutes.

Updating the start of hydrogen production setpoint e.g., every 5-15 minutes is advantageous in that it has the effect, that production of hydrogen then can be adapted to change in price of electric energy received from the utility grid. It should be noted that the update frequency in general in this document including update of event status may be done every second such as with a sample rate of 2-5 seconds or as fast as hardware and software together allows.

Transmitting should be understood as communicating i.e. a communication from the system controller to the local controller of the electrolyser.

According to an embodiment of the invention, said system controller is providing hydrogen production setpoints to said electrolyser based on said power supply information.

This is advantageous in that it has the effect, that production of hydrogen can be optimized to requests from consumers and thereby optimizing (including possible reduction of) storage capacity in the hydrogen infrastructure system.

Further, this is advantageous in that it has the effect, that the connection of the electric load of the electrolyser to the electric grid can be controlled and thereby the electrolyser can be used as grid support in some situations by either starting or stopping production.

According to an embodiment of the invention, said quantity of produced hydrogen is produced for storage in a particular mobile hydrogen storage or stationary hydrogen storage.

This is advantageous in that it has the effect, that the system controller is able to maintain status on production of a quantity of produced hydrogen requested by a particular industrial consumer. Further, it allows the industrial consumer to track precisely from where energy used to produce the requested quantity of hydrogen origins. Hence it may be possible for the system controller to track the power down to a single wind turbine or solar park delivering power to produce a requested quantity of hydrogen.

According to an embodiment of the invention, said hydrogen production setpoints are furthermore depending on a weather forecast and/or a request forecast.

This is advantageous in that it has the effect that production of a particular quantity of certified green hydrogen may be started in dependency of expected power production and delivery from a particular power source (such as a wind or solar power generating farm). Thereby it is possible to ensure best possible that the quantity is produced and delivered on timer.

According to an embodiment of the invention, the system controller categorize said produce hydrogen in batches and attach batch information to said hydrogen batch, wherein said batch information is updated at least once before reaching its final destination.

This is advantageous in that it has the effect, that batch information and thereby how a batch can be matches with a request can be change over time. Batch-specific information can be attached to a batch of hydrogen, and additional information can be added if relevant at a later time. Hence, a batch of green hydrogen (100% renewable energy is used for production), produced at location A, being pressurized to a higher pressure, using a mix of green energy and not green energy (increasing the CO2 print of the batch). Thereafter the hydrogen is transported to location B using a petroltruck (again increasing its CO2 print), where it is partly or fully consumed. The remaining hydrogen is then transported to the next location C, and the impact on the greenness of the batch (or remaining part) can be added to the batch information.

According to an embodiment of the invention, said system controller divides one or more produced batches of hydrogen into two or more requested quantities.

This is possible because the system controller knows which batch of produced hydrogen that is stored in which part of the stationary and/or mobile hydrogen storage and thereby information of e.g., price, time, type of power, etc. that was used to produce hydrogen of the individual batch. Hence this is advantageous in that it has the effect, that hydrogen can be produced in advance of it being requested by a consumer.

Hence, if the system controller cannot comply with all requests when receiving these e.g., due to limited hydrogen on storage, the system controller is able to analyse the request requirements and then identify which requests it is possible to match. Then the system controller is able to give priority to production of hydrogen that matches the yet not matched requests when price, weather, etc. allows.

According to an embodiment of the invention, said system controller is providing hydrogen production setpoints to said electrolyser to start hydrogen production based on at least one of the parameters comprised by the list of parameters comprising: type, price, time of delivery, volume and means for transportation.

This is advantageous in that it has the effect, that hydrogen can be produce according to what historically has turned out to be most valuable in terms of price, request, etc. In this way it is possible to produce and store the most valuable batches of hydrogen when possible.

Means for transportation should be understood e.g., as by a mobile trailer or by pipeline. The time of delivery should be understood as urgency of the consumer to have the hydrogen delivered.

According to an embodiment of the invention, said request is associated with a consumer profile of a hydrogen community.

Associating a request with a user profile is advantageous in that it has the effect, that the system controller already upon receiving the request know various details of the consumer. These details may include if the consumer is able to receive hydrogen via tube trailer, address, billing address, etc.

According to an embodiment of the invention, said request comprises one or more request requirements.

This is advantageous in that it has the effect, that the industrial consumer is able to give priority to different characteristics of the quantity of hydrogen that he is requesting. Hence to one consumer delivery speed may be important, to another delivery method may be important, to another type of hydrogen may be important, etc. Thus, request requirements related to delivery time and method and hydrogen type can be prioritized differently between consumers according to the present invention.

According to an embodiment of the invention, said request is autogenerated by a local controller of the industrial consumer.

Such automated generation of request may be advantage to the consumers in that such autogenerated request may at least be used as a back-up if e.g., an operator forgets to order e.g., a new full mobile hydrogen storage if e.g., an existing mobile hydrogen storage located on site of the industrial consumer reaches a lower threshold value.

According to an embodiment of the invention, said system controller is sorting a plurality of said requests according to said request requirements.

According to an embodiment of the invention, said system controller is confirming and delivering requested hydrogen according to said sorted requests.

Sorting requests is advantageous in that the system controller then is able to prioritize which request to confirm and deliver/confirm first if not all requests can be confirmed and delivered at the same time. This may be the case if the volume of available hydrogen e.g., of a particular category is limited or if the number of available tube trailers is limited.

The sorting may be done according to one or more requirements of the requests.

According to an embodiment of the invention, said power supply information comprise information identifying the power plant producing power to said electrolyser producing said quantity of requested hydrogen.

Being able to identify from which power plant such as from which wind turbine, wind power park, solar cell, etc. power is produced is advantageous in that local agreement between power supplier and hydrogen consumer can be facilitated. Such agreement could regulate production window, price, etc.

Information identifying the power plant may include name, address, type of power plant, production capacity, availability, etc.

Further, by knowing the power producer, a certificate can be associated with a given batch or quantity of produced hydrogen. Such certificate may be important for the consumer e.g., if the consumer has obligations related to a Carbon Dioxide footprint.

According to an embodiment of the invention, said power supply information comprise future production estimations.

Future production estimations and thereby future available hydrogen may be made locally by a controller of the power plant e.g., based on a weather forecast, service forecast, etc. Alternatively, the system controller may predict future power production based on the same information as would found basis for a local prediction.

According to an embodiment of the invention, said power supply information comprises information related to stability of grid and/or load of said power plant.

The grid stability information may be established and delivered from the grid operator or estimated from information of grid frequency and power flow data. Knowledge of grid stability is advantageous in that it is possible to predict which colour of hydrogen it is possible to produced and thereby how and how well it is possible to meet a specific request from a particular consumer.

Similarly, information of load from the power plants electrically connected to the electrolyser can be used to assess if it is possible/when it is possible to meet a request of a specific request of hydrogen.

According to an embodiment of the invention, said quantity of hydrogen is defined as a subset of a batch of stored hydrogen.

A quantity of hydrogen should be understood as a volume of hydrogen. Such volume may be defined e.g., by a density or by weight. Hence, a quantity may be considered defined when a given density is reached in a storage cylinder or when a given weight of a storage cylinder is reached.

The hydrogen storage (mobile or stationary) may comprise hydrogen which has been produced under favourable conditions such as cheap energy price even though there are no current request from a consumer. Thus, there may be a margin for the system operator to gain when subsequently selling a requested quantity to a consumer.

According to an embodiment of the invention, said quantity of hydrogen is produced on request according to said request requirements.

Being able to produce hydrogen on request i.e., when a consumer has already ordered a quantity of hydrogen, is advantageous in that it reduced the financial risk bound to the hydrogen production for the system operator.

According to an embodiment of the invention, said system controller convert at least part of said quantity of hydrogen from one type of hydrogen to another type of hydrogen.

This is advantageous in that it has the effect, that by converting e.g. green hydrogen to grey hydrogen, the system administrator may be able to comply with a received consumer requests faster than if otherwise production of grey hydrogen is needed. Thus, if e.g. the relationship of pricing of green and grey hydrogen e.g. due to speed of delivery is correct conversion from green to grey, which from a first point of view is irrational would make sense from a business point of view.

According to an embodiment of the invention, said system controller associates said batch of produced hydrogen with hydrogen production data.

The hydrogen production data is associated with the produced hydrogen either as production is made or after the hydrogen is produced.

The hydrogen production data such as from which power plant power to electrolyser is from, price of energy, volume, etc. is associated with the batch of hydrogen e.g., in a data storage associated with the system controller. Hence, the system controller known in which storage hydrogen produced at a particular time of the day is storage. During this particular time of the day, particular power supply conditions are present allowing production of a given volume. Hence, these examples of hydrogen production data are stored and in the data storage linked to the vessel or vessels of a hydrogen storage. In this way, the system controller is either real-time or subsequently able to determine if already produced hydrogen comply with request requirements and thus if a match between a batch of hydrogen can be made with a request.

Hence, the hydrogen batch is matched with initial batch information, preferably the initial batch information is updated before the batch is delivered to or consumed at the end consumer.

According to an embodiment of the invention, said match between said request requirement and said batch of hydrogen is subsequently updated.

According to an embodiment of the invention, said update is made based on an event occurring at an infrastructure member.

Hence, a request may be re-matched with other batches (quantities) of hydrogen based on an event occurring in the infrastructure system. Thus, a hydrogen batch matched with a first request may ultimately be matched with second or third request before delivered to consumer. Further, the consumer may also change request requirements before delivery of the hydrogen.

As mentioned, events that may initiate a rematch or an updated request requirement may be an event at one or more infrastructure elements having impact on production, delivery, etc.

According to an embodiment of the invention, said system controller is establishing at least one hydrogen production setpoint based on said request requirements, wherein said at least one hydrogen production setpoint is communicated from said system controller to a local controller, of said electrolyser, wherein said local controller starts production of hydrogen when said at least one hydrogen production setpoint is complied with.

Accordingly, the electrolyser may wait to the correct conditions are present before it starts to produce hydrogen. In this way, a not yet produced batch or quantity of hydrogen, is matched with a request. Hence, the hydrogen may be produced when the electrolyser is able to comply with the production setpoint. This may happen e.g. when a price or hydrogen type specified by the request requirement is present in the energy or hydrogen market.

According to an embodiment of the invention, said hydrogen produced according to said request requirements is stored in a mobile hydrogen storage.

Accordingly, a user defined quantity of hydrogen can be produced in that the hydrogen is produced based on user defined request requirements. Hence, as an example, a consumer may specify, via the request requirements of the request, that 100 kg of green hydrogen (requirement 1) and 400 kg of brown hydrogen (requirement 2) is needed to be delivered at 12 am on Tuesday (requirement 3) in a trailer (requirement 4).

According to an embodiment of the invention, said match is performed by said system controller by identifying said at least one request requirement and compare said at least one request requirement with a corresponding hydrogen production data associated with hydrogen stored in said stationary hydrogen storage or in said mobile hydrogen storage.

The hydrogen production data may be stored in a data storage accessible by the system controller. The request requirement of the request may also be stored in such data storage.

According to an embodiment of the invention, said system controller subtracts an amount of hydrogen corresponding to the quantity of hydrogen shipped based on said request from said hydrogen stored in said stationary hydrogen storage or in said mobile hydrogen storage.

Accordingly, hydrogen may be stored in the stationary storage and/or in the mobile storage. As mentioned, the system controller has stored hydrogen production data associated with the stored hydrogen. Thus, if the stored hydrogen comprises 200 kg green hydrogen and 400 kg of brown hydrogen, then if a quantity of 100 kg of each are shipped based on a request, the hydrogen production data specifying quantity of green and brown hydrogen respectively is subtracted 100 kg.

An amount of hydrogen should be understood as a volume/quantity of hydrogen.

According to an embodiment of the invention, said system controller establishes an alternative hydrogen quantity if hydrogen stored in said stationary hydrogen storage or in said mobile hydrogen storage does not match said at least one request requirement.

This is advantageous in that it has the effect, that even though the consumer cannot receive hydrogen according to the specified request requirements, the consumer is offered an alternative. In this way, the consumer may continue production even though the hydrogen is not green if this was the requirement that was not possible to comply with.

According to an embodiment of the invention, said system controller is planning delivery of said quantity of hydrogen to said at least one industrial consumers.

Planning of distribution in the context of the system controller at least includes providing information of quantity requested or sold to a given consumer. The distribution planning is made either by the system controller or by a controller communicating with the system controller. The planning is made based on information of physical location of storage of batches of hydrogen (including meta data associated with the batches of hydrogen) and of physical location of point of delivery of the hydrogen to the consumer.

According to an embodiment of the invention, said mobile hydrogen storage communicates with a mobile hydrogen storage tracking system.

This is advantageous in that a system controller communicating with the tracking system is able to monitor where a mobile storge is physically locate, its State of Charge, expected time it is available, etc. Based on this, the system controller is able to plan delivery of the hydrogen quantities requested by the consumers.

According to an embodiment of the invention, said system controller is able to give priority to a first mobile hydrogen storage over a second mobile hydrogen storage to comply with a request for hydrogen, independent of type of hydrogen that is comprised by said first and second mobile hydrogen storages.

This is advantageous in that it had the effect that if one trailer comprises 500 kg green hydrogen but suffer from mechanical defects and is not able to move and another trailer comprise 500 kg brown hydrogen and is able to move. Then the system controller is able to “switch” so to the second trailer is delivered to the consumer as green hydrogen and the content of the first trailer in the data storage is change to brown hydrogen.

According to an embodiment of the invention, said plurality of industrial consumers are registered with consumer information in a consumer database accessible by said system controller

According to an embodiment of the invention, said registration furthermore include at least the presence of a mobile hydrogen storage connection fluidly connected to a hydrogen transmission line leading to a construction of said industrial consumer.

Based information of such consumer database the system controller is able to provide a truck drive with address of a consumer that need a particular trailer delivered.

Construction should be understood as a building such as an office building or production building.

According to an embodiment of the invention, said system controller establish a certificated of said quantity of hydrogen and track wherein said hydrogen infrastructure said quantity of hydrogen is.

This is advantageous in that it has the effect, that then the system controller known where the certificate is. This information can be useful to the consumer in that it is possible for the consumer to plan production based on information of when the certificate is received.

According to an embodiment of the invention, said at least one of the list comprising is predicted based on the result of processing of a machine learning algorithm, said machine learning algorithm being trained with actual historic data and/or structural data.

A prediction may be understood as an output of a machine learning algorithm. The machine learning may have been trained based on previous acquired data related to operation of the hydrogen infrastructure.

It should be noted that one single machine learning algorithm may provide predictions for the different queries from a user. Or, optionally, different machine learning algorithms may be applied in relation to obtaining predictions for different queries or from different user or user segments.

The invention relates to a method described in the paragraphs-implemented in a system described in the paragraphs-[0067].

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1 illustrates an overview of a hydrogen infrastructure,

FIG. 2 illustrates a detailed overview of a hydrogen infrastructure,

FIG. 3 illustrates an overview of communication in a hydrogen infrastructure,

FIG. 4 illustrates a flow chart of steps related to requesting an amount of hydrogen,

FIG. 5 illustrates a flow chart of steps related to control of production of hydrogen independent of consumer requests, and

FIG. 6 illustrates a flow chart of steps related to sale and distribution of an amount of hydrogen.

### DETAILED DESCRIPTION

The present invention is described in view of exemplary embodiments only intended to illustrate the principles and implementation of the present invention. The skilled person will be able to provide several embodiments within the scope of the claims.

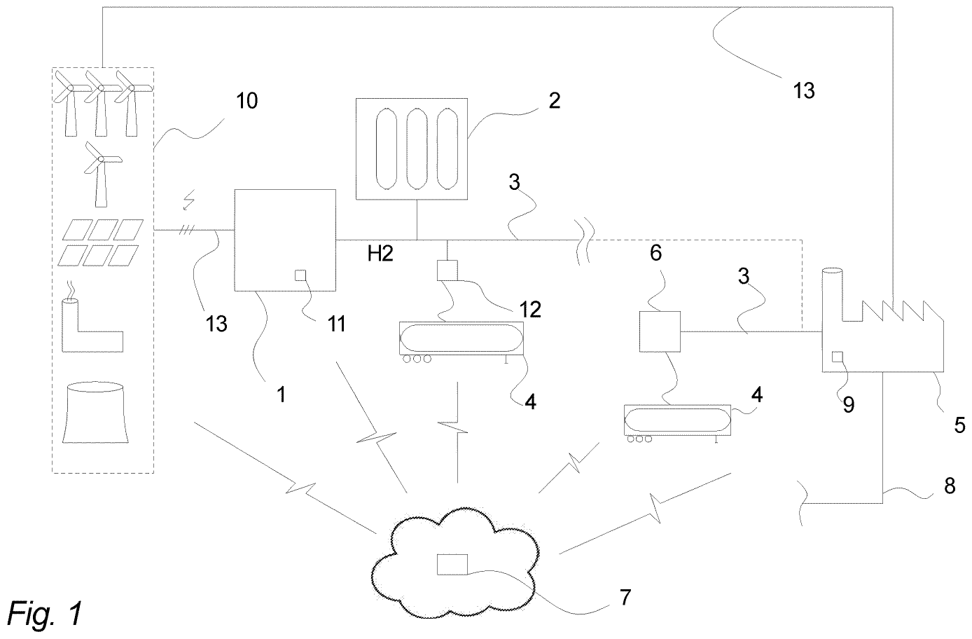

FIG. 1 illustrates an overview of infrastructure members according to an embodiment of the invention that together in this document are referred to as a hydrogen infrastructure. The infrastructure members include electrolyser 1, stationary storage 2, piping/pipelines 3, mobile storage 4, industrial consumer 5, system controller, gas supply 8 and power plant 10. It should be mentioned that not all of these members are represented in the same infrastructure and that an infrastructure may comprise a plurality of one particular member.

The hydrogen infrastructure illustrated in FIG. 1 is considered a closed loop with a finite amount of available hydrogen at a given time (i.e. produced hydrogen on storage) and a maximum capacity (i.e. upper limit of what can be produced and what can be stored). The maximum capacity is also referred to as the buffer capacity which optimally ensure to cover fluctuation in the hydrogen production so that consumer request can be met without any interruption in hydrogen supply.

Thus, the present invention suggest how it can be ensured that the available hydrogen and in particular certified hydrogen such as certified green hydrogen can be distributed in the infrastructure. This distribution is made so that the consumers that request hydrogen of a particular category is receiving such hydrogen according to agreed request requirements and price.

The electrolyser 1 may be any type of electrolysers pressurized or atmospheric. An electrolyser is converting electric energy into gaseous energy hence it is powered from a power supply and being able to produce gases including hydrogen from water. The electrolyser could therefore be said to be the start of the gaseous part of the hydrogen infrastructure.

The electrolyser may be controlled by a dedicated local controller 11 or by the system controller 7. If controlled by a local controller 11 it may at least partly control the hydrogen production based on input from the system controller 7.

In an embodiment, the system controller 7 is executing an event-based control algorithm. Based on this algorithm, the system controller is able to determine the most optimal hydrogen production and distribution with reference to the value chain, as well as transportation and balancing of grid. The system controller (and the local controllers) may be a cloud controller, an industrial programmable controller or similar data processing devices.

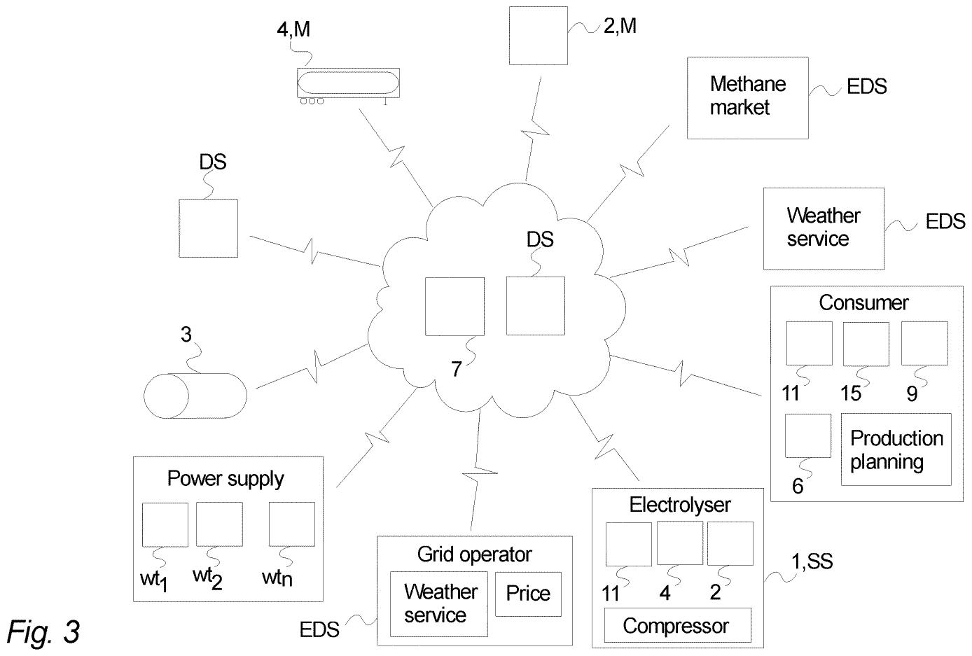

The communication in the communication channels between system controller 7 and the different members of the infrastructure (such as those illustrated in FIG. 3) may be event-based/event-driven. This should be understood as, when something happens in the value chain, it is detected by an IoT sensor. Then an event is created which is broadcasted throughout the hydrogen infrastructures software systems. The event may be created at the system controller 7 or at the member that of the infrastructure having a data processor capable thereof. When created it is broadcasted to all or most of the members of the infrastructure. All components or members of the infrastructure having a suitable data processor/controller is looking for events. However, only when a member sees an event that is directed to it or to its type, the member reacts to it.

Thus, in principle anything that can be an electrical signal, in any way, shape, or form, can be converted into an event, that then is introduced to the event-stream which feeds it to its relevant systems, warning the right people/elements, or right systems, which then is able to react thereon and take the appropriate action.

As a non-limiting example, if an IoT sensor senses that a tire of a trailer is punched on the trailers way to an electrolyser this incident converted to an event that is broadcasted in the communication system. The event i.e. the data that is broadcasted may include information regarding position of the trailer, destination of the trailer, what incident happened, time of incident, etc. Accordingly, the electrolyser waiting for this mobile hydrogen storage to arrive registers this event and realise that it misses a storage for produced hydrogen. Hence, another event may be broadcasted requesting another trailer to come. Alternatively, the hydrogen production plan e.g. for the next 24 hours is updated. The updated hydrogen production plan may under the new circumstances find the optimal production/fill/distribution time for the trailer in this new scenario.

Another non-limiting example is if an electrolyser breaks down due to any reason, it now broadcasts a signal of unavailability as well as a signal explaining the error among the elements of the hydrogen infrastructure (and externals if relevant) via the event stream. The error message is known by the elements, and the error is associated with the changing of a component of the station, a simple operation that takes a couple of hours.

As the event is broadcasted into the event stream, elements such as a notification system, the operator system, customer app, and the logistical system receives it and thereby is able to react on the received information. The reaction may be predetermined or depending on input from other elements.

When the notification system receives the information of the breakdown, automatically the system consults a database related to operation and spare parts of the electrolyser. Further, the notification system determines if the spare part is available on stock or it need to be purchased e.g. by consulting a warehouse database. If the spare part is available and there is no service operator available, the task of replacing the spare part will automatically be added to a to do list of one or more service operators.

If the spare part needs to be purchased or if it is the last on stock, the operator system may automatically identify or verify the spare part from the received information and place a purchase order at the relevant vendor. Further, it may update the status on stock for that particular spare part in the warehouse database to “low”

All customers the have subscribed to receive news e.g. via a dedicated smartphone application will also receive the news about the malfunctioning electrolyser. This information may be a push notification explaining the situation and giving recommendations on when the defect is expected to be solved, where hydrogen can be delivered in the meantime and the like.

The logistical system also receives the event. Based on the received event information, expected offtake from the electrolyser is updated, and a rearrangement of production/delivery plan in relevant nearby production facility is made if considered needed.

Put in another way, the communication channel (also referred to as communication system) could be described as raw data that is received from the members of the infrastructure. The transmission of data is facilitated by the communication channel which may be based on wireless communication protocol known e.g. from SCADA, IoT or VPN communication. These members are typically not under the direct control of the system administrator/system controller 7, but independently controllable by local controllers. As an example could be mentioned tube trailers which may be considered a closed environment where each trailer has a private gateway with a private access point name. Hence, the trailers may establish their own data cloud from where the system controller is accruing data related to the trailers e.g. via a IoT hub. Alternatively, each trailer may communicate with the system controller/system cloud.

Depending on the received data, a filtering or translation of this data is made to “clean” the “raw data” and thereby only the relevant data is broadcasted in the communication system. This translation may be done either at the system controller or at the member providing the data. If done at the individual members e.g. prior to broadcasting the data, the filtering may e.g. be done by the local control according to a software that is working as communication interface with the system controller.

The data may as described above be broadcasted via one or more communication channels which also may be referred to as a central even stream. Each of the members of the infrastructure may have a communication interface that enable the member to broadcast and read data communicated through the central event stream.

In fact, according to an embodiment of the invention, one way implementing the control of a system with members as illustrated e.g. on FIG. 3 is to establish digital twins of the individual members. The digital twins may be used to simulate the effect one event from one member have on the whole value chain of infrastructure members. In this way it is possible to simulate what happens if e.g. a trailer is not returned to an electrolyser as scheduled, an electrolyser is malfunctioning, plane production based on weather forecasts, etc.

Further, when input from the real members of the infrastructure is used in as input to the digital twins, the digital twins may also be used to establish setpoints to the real members of the infrastructure and thereby used in the control thereof.

The digital twins may be stored on the data storages associated with the system controller and thus the system controller may be configured for controlling the simulations and the data in the central event stream.

It should be mentioned that when referring to a member of the infrastructure relevant external members such as external data sources and the like illustrated in FIG. 3 may also be included in such reference.

The hydrogen produced by the electrolyser 1 is via pipelines 3 distributed to a storage or directly to a consumer 5. A typical scenario is that hydrogen is temporary stored in a stationary storage 2 or in a mobile storage 4 when produced and subsequently delivered to the consumer 5. To be able to store more hydrogen in the same storage volume a compressor may be used to pressurize the hydrogen in the storages. The storage pressure may be between 20 MPa and 100 MPa.

A stationary storage 2 may comprise a plurality of cylinders fluidly connected to the hydrogen transmission line 3. The transmission line 3 may end at the stationary storage 2 or at a mobile filling hub 12. The mobile storage hub is where one or more mobile hydrogen storages 4 can connect to the transmission line 3 and thereby indirectly to the electrolyser 1 and/or stationary storage 2 and be filled with hydrogen.

The stationary storage 2 is stationary in that it is not intended to be moved. Hence, it may be built up of cylinders in a casing which casing is movable e.g. by a crane. Further the stationary nature of the stationary storage 2 is also seen in the valve connection to the transmission line 3 which is through valves that may allow or deny flow of gas to and from the individual cylinder and/or casing of cylinders.

Such valves and compressor mentioned above may be controlled by one and the same controller. It may be the same controller controlling the electrolyser or it may be the system controller 7. Alternatively, the valves and compressor may be controlled by a compressor controller communicating with the controller 11 controlling the electrolyser. In any case, the controller controlling the compressor and valves may be communicatively connected with the system controller 7.

It should be mentioned that the transmission line 3 may also be considered a stationary storage, And it should be mentioned, that the system controller control storage of hydrogen in at least one of the stationary hydrogen storage and the mobile hydrogen storage,

The mobile storage 4 is preferably tube trailers that is connectable to a mobile filling hub 12 at an electrolyser side and to a mobile hydrogen storage connection 6 at a consumer side. Typically, the hydrogen infrastructure includes a plurality of mobile storages 4 distributed in the infrastructure so that some are being filled, some are on the way to the electrolyser side, some are on the way to the consumer side and some are being discharged or used as temporary storage at the consumer side.

As an example, the storage capacity of such tube trailer 4 is between 1000 kg and 2000 kg. Typically, the pressure in the cylinders of a tube trailer 4 that is considered full is between 30 MPa and 90 MPA such as e.g. between 30 MPa and 75 MPa. Alternatively, a cylinder/tube trailer is considered full when it has a density between 20 kg/m3 and 50 kg/m3 such as e.g. between 25 kg/m3 and 46 kg/m3 at a temperature between 20° C. and 25° C.

It should be mentioned, that both the stationary and the mobile storage may be divided in sections. Sectioning of storages allows an optimized utilization of energy used to fill and empty trailers in that filling/emptying can be made with an optimized balance between use of pressure equalisation and compressor.

It should be mentioned that at least the stationary storage 2 and the mobile storage 4 are equipped with sensors such as IoT (IoT; Internet of Things) sensors for communicating with controllers such as the central controller 7. Other members may also include sensors and such sensors may allow the members to provide information to relevant controllers relating to positions data (e.g. via GPS systems (GPS; Global Positions System)), temperature, pressure, SoC (SoC; State of Charge), time, hydrogen flow, ambient temperatures, temperature inside a storage such as inside the individual cylinders of a storage (mobile or stationary), pressure inside a storage such as inside the individual cylinders of a storage (mobile or stationary), etc.

An industrial consumer 5 should be understood as a process including the use of a gas for treatment, heating, etc. An industrial consumer/process may also include a refueling station for vehicles, trains, air born vehicles, etc. Thus, an industrial consumer 5 may in principle be defined as a consumer of hydrogen where the amount of consumed hydrogen justifies delivery of the hydrogen in a pipeline or in a tube trailer.

It should be mentioned that industrial consumers 5 may also include consumers that are using natural gas but could change to hydrogen or a mix of hydrogen and natural gas. Such natural gas may be delivered via a gas supply line 8. The gas supply line 8 may be used to deliver to a consumer methane gas, hydrogen gas, biogas such as methanation or a mix of at least two of the mentioned gases. As example a methane gas may be mixed with e.g. 5% hydrogen gas.

An industrial consumer 5 may burn e.g. hydrogen gas, methane gas or a mix hereof in a burner 9 which may be a variable burner. In this way the consumer is able to use the gas available, cheapest or a mix of gases. This type of industrial consumers 5 may comprise a controller controlling the burning process and thus the flow of hydrogen from the mobile hydrogen storage connection 6. Hence, there may be communication from either the mobile hydrogen storage connection 6 and/or from the controller of the consumer 5 to the system controller 7.

The power plant 10 is producing and supplying electric energy to an electrical grid 13. The electric grid 13 is supplying power to both electrolysers 1, industrial consumers 5, households, vehicle charger and everything else that need electric power supply. Accordingly, an industrial consumer 5 as illustrated in FIG. 1 may be supplied with power from one or more sources including the grid 13, hydrogen transmission line 3 (illustrated as stipulated in that it may be supplied solely from mobile storage) or gas supply line 8.

The power plant 10 may be seen as a plurality of electric power producing units as one whole or as a plurality of individual power producing units. A grid operator know the origin of the power available in the grid 13, the capacity of the individual power contributors and thus is regulating power flow in the grid. Therefore, information from the grid operator is relevant to optimal implementation of the present invention. The information comprised by the grid operator is for some part received via communication with park controllers or controllers of individual power producers.

The contributors to power available on the grid 13 may be one or more of wave energy plants, wind turbines, thermal plants, photovoltaic plants, hydropower, nuclear-, coal- or gas-based power contributors. Thus, with knowledge of power contribution from each of the individual plants 10 and knowledge of power consumed, it is possible to determine type of power used by an electrolyser to produce hydrogen.

Manage quantity should be understood as schedule and reschedule of the production of hydrogen and as manage the location of hydrogen in the infrastructure system. Note that a quantity may also sometimes be referred to as a batch.

Manage currently available hydrogen of hydrogen infrastructure system and of future available hydrogen in hydrogen infrastructure system to comply with a request in the most optimal way may include matching the request with currently available hydrogen, with future available hydrogen or with a combination of currently and future available hydrogen. Thus, a request may be matched with a mix of currently available and future available hydrogen. This said, a request may be re-matched with other batches (quantities) of hydrogen. Thus, a hydrogen batch matched with a first request may ultimately be matched with second or third request before delivered to consumer. In this way, the most optimal match between request and available hydrogen can be made in terms of cost of production, cost of distribution, cost of storage, etc.

Schedule production of hydrogen is based on information of one or more of availability of production capacity in electrolysers, current and expected future energy prices, storage capacity in fixed and movable storage, weather, etc. Hence, if a truck trailer is available in five days and production cost are estimated to be lowest on day 4 and 5, then production is scheduled to day 4 and 5 of the five days. In this way, the truck is only needed at day 4 and 5 leading to a cost reduction on the distribution of hydrogen.

Reschedule of production is to some extent based on events observed by the system controller and/or expectations (predictions) of consumption, production, weather, pricing, etc. Rescheduling may be understood as a recalculation i.e. do not necessarily result in any changes. Hence, if there are nothing to gain by changing production slot, there may not be a reason for changing in the already scheduled production. A rescheduling may as mentioned be triggered by events, but may in addition or as alternative also be predetermined e.g. at intervals of 5, 10, 15, . . . 60, 65, 70, . . . 120, 125, 130, etc. minutes.

Scheduling, rescheduling, matching and rematching may include establishing an overview of currently available hydrogen, a purchase order for a given type of energy needed to produce hydrogen (defined by the request), order truck trailer for delivery, order production slot at an electrolyser, etc. As these elements all are associated with costs, the rescheduling and rematching is advantageous in that before delivery of the requested hydrogen, prices on e.g. green energy or production slot may change and thereby lead to a reconfiguration of the composition of hydrogen, production and method of deliver of the needed hydrogen to comply with the request.

An event could be an energy price over or under a predetermined threshold, unexpected interruption of production and/or power supply, disturbances in the distribution change (e.g. an unexpected stop of a truck moving a movable storage), etc. A threshold could be a minimum quantity of stored hydrogen, energy price, availability of electrolysers, etc. A disturbance in the distribution change may include a leak of a pipe or storage (measure be a change of temperature or pressure in a given time period), the stand still of a truck for a given period, tyre pressure drop of a truck, etc. such information may be provided to the system controller from local sensors (e.g. IoT sensors) or local controllers receiving data from sensors. Another example is the system controller may communicate with a traffic information center and with the truck. If the system controller is informed that the truck suddenly drives 0 km/t and receives information that no tailback is present at the location of the trailer, the system controller can establish that something has happened and send help to the truck. Further, the consumer may be notified of the late arrival of the requested hydrogen, delivery of an alternative hydrogen quantity from a different source, etc.

The request may include request requirements such as quantity of hydrogen, type of hydrogen, time of delivery, place of delivery, etc. Accordingly, the matching and preferably rematching of request with available (current or future) hydrogen have to meet the request requirements. Thus, as the availability of hydrogen is dynamic, the most profitable match between available hydrogen and request may change one or more times from when the request is received by the system controller and to the time of delivery. It should be mentioned that a request from a consumer may include one or more first and a second priorities. Hence, a first priority could be delivery at a given day and second priority could be price or vice versa. Hence, the consumer may be ok with a late delivery if the prices is sufficiently low as long as the hydrogen is delivered before a specific date.

An example of the most optimal (such as most profitable) match should be understood as the match requiring least energy, least time, least resources and/or least cost to comply with in terms of production and distribution. Another example of an optimal match may include a rearrangement of hydrogen quantities (currently or future available) between existing and/or new requests. Hence, if a first consumer is willing to pay a higher price to have an earlier delivery, then a hydrogen quantity that was already assigned another consumer may be delivered to the first consumer. This is also an example of re-matching/re-scheduling.

It should be noted that a request may also be updated after having first been received by the system controller, such update may be initiated by the system established the request.

Accordingly, the system controller could be said to have a first and a second priority for matching a request. If the first priority fails for some reason, the request may be complied with by the second priority. First priority may as an example be time of delivery in a particular trailer from a particular electrolyser. If this fails, the hydrogen is delivered according to the second priority which may be determined by the system controller and which may include an alternative source of hydrogen or an alternative truck trailer. Hence, the consumer may not notice any differences.

Accordingly, the present invention emphasize the dynamic allocation of hydrogen resources to meet current and future requests. And the system can rematch hydrogen batches with different requests to optimize cost of production, distribution and other factors. This dynamic approach to managing hydrogen resources including the reconfiguration of hydrogen allocation based on changing conditions is especially advantageous. Further, the invention is advantageous in that the system controller based on available information from infrastructure elements is able to manage and optimize hydrogen distribution in response to a variety of dynamic factors, emphasizing flexibility, consumer-centricity, and real-time responsiveness towards those customers.

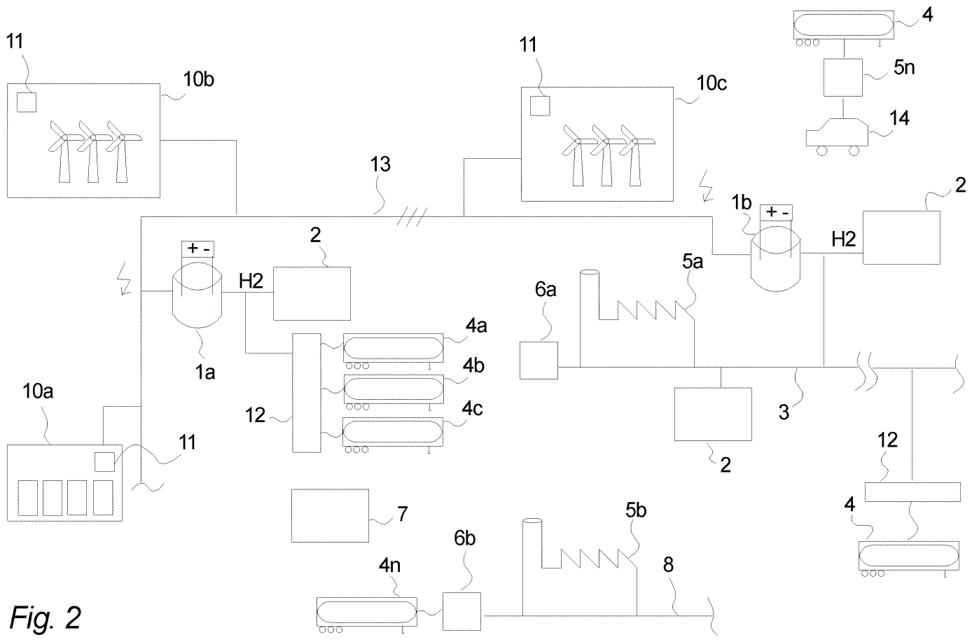

FIG. 2 illustrates a hydrogen infrastructure according to an embodiment of the invention comprising a photovoltaic power producer 10a and two wind farms 10b, 10c all connected to an electric grid 13. To the electric grid 13 is connected a first and a second electrolyser 1a, 1b. The hydrogen refueling station 5n and the two additional industrial consumers 5a, 5b would typically also be connected to the grid 13 this is however not illustrated for simplicity. Relevant transformers, AC/DC or DC/AC converters needed for connecting the power plants 10 and electrolyser to the grid are also not illustrated.

The first electrolyser 1a is illustrated at connected to the grid 13 at one side and part of the hydrogen infrastructure on the other side. More specific, this first electrolyser 1a is connected to stationary storage 2 and a mobile filling hub 12. The mobile storage hub facilitates connection of mobile storage such as tube trailers. It may be possible to connect a plurality of tube trailers to one filling hub 12. The number of tube trailer connections of the filling hub 12 would typically be matched with the capacity of the storage 2 and of the electrolyser 1a. Thus, 2-100 or even more simultaneous connected tube trailers may be facilitated.

The second electrolyser 1b, is as the first electrolyser 1a connected to a storage 2 and to a hydrogen transmission line 3. This hydrogen transmission line 3 is fluidly connected to a first industrial consumer 5a via which hydrogen can be supplied to the consumer 5a. As illustrated, the transmission line 3 is also connected to a filling hub 12 which is located remote to the electrolyser 1b.

The consumer 5a also comprise a mobile hydrogen storage connection 6a for connecting a mobile storage 4. Thus, the consumer 5a is able to receive hydrogen both from a mobile storage 4 and via the transmission line 3. Thereby, this consumer 5a is more flexible (has less request requirements) when requesting hydrogen and thus may be able to obtain hydrogen to a lower price, at a more specific point in time, a specific variant of hydrogen (specific colour), etc. This is at least true when comparing to the second consumer 5b which is not connected to the transmission line 3 and thus only is able to receive hydrogen via mobile storage 4. The second consumer is however also connected to a gas supply line 8 via which natural gas such as Methane may be received. Thus, in terms of variety of types of gas, the second consumer 5b is more flexible than the first consumer 5a.

The third consumer 5n is illustrated as a refueling station refueling a fuel cell vehicle 14. The supply storage of the refueling station is a mobile storage 4, as it is a remote located fueling station. But could if located in proximity of a transmission line 3 be connected to such.

Consumers 5 only supplied with hydrogen from a mobile storage 4 is typically not connected to a transmission line 3. Instead, they are located within a radius of from a mobile filling hub 12. Such radius could be a distance of a few kilometres to several hundred kilometres or even more depending on how developed the infrastructure is. Hence, the infrastructure is developed with a combination of backbone transmission lines 3 having “fingers” ending in filling hubs 4 in areas where the consumption from or number of consumers is relatively low.

The infrastructure is powered by one or more power plants 10. These power plants 10 may be based on different energy sources such as solar, water, heat, wind, coal, nuclear, biomass, etc. These power plants 10 may comprise one single power generator or multiple referred to as a part or farm. No matter if a power plant is one single wind turbine 10 or a wind farm, a local controller 11 is used to control the wind turbine and/or the wind farm. These local controllers 11 are communicating with the system controller 7 which thereby is able to determine type of power source for production of hydrogen at a specific electrolyser 1.

It should be noted that a wind turbine or photovoltaic power plant may not be connected to the grid 13. Instead, it may be connected to an electrolyser and a hydrogen transmission line 3 from the wind turbine would be part of the hydrogen infrastructure.

As indicated on FIG. 2, the infrastructure may comprise two or more individual infrastructure parts which together is referred to as the hydrogen infrastructure. The individual parts may be characterized in that no fluid communication can be established between the individual parts. The individual parts may be similar i.e., with the same members included. The individual parts may be combined via the mobile storages 4 thereby hydrogen may be moved from one of the individual parts to another part. Hence, a trailer 4 may be filled at one filling hub 12, emptied at another and filled again at a filling hub 12 different than the first. The filling hubs may be connected to different electrolysers 1 and even to different infrastructure parts.

Thereby, the hydrogen infrastructure is developed as to be able to deliver hydrogen to as many consumers with as low overall cost (developing and operating the infrastructure) as possible. This may include e.g., a single or a few wind turbines or photovoltaic panels that is connected to an electrolyser. The electrolyser may be fluidly connected to a transmission line 3, storage 2 filling hub 12, etc. and thereby forming a small island infrastructure.

It should be noted that the infrastructure members illustrated on FIG. 2 only represents a small part of members of a hydrogen infrastructure which may also count private households and other consumers. A hydrogen infrastructure in the content of the present invention is comparable to the electric grid connecting all consumers to a network of transmission lines 3. Where the infrastructure is not yet built or where establish transmission lines is not profitable, hydrogen is delivered via the mobile storages 4.

Thus, the consumers 5 of FIG. 2 is only to illustrate examples of how they can be connected in the infrastructure e.g., with a mix of gas supply line 8, hydrogen transmission line 3 and mobile storage 4 or only one of these. Finally, it should be mentioned that large consumers may have their own electrolyser, their own stationary storage 2 (as consumer 5a).

As will be explained below with reference to FIG. 3 the production and flow of hydrogen in the infrastructure is controlled by a system opera tor via a system controller 7. The system controller may communicate directly with the members of the infrastructure or to controllers of the members. Hence a power plant 10 and an electrolyser 1 may both have local controllers 11 communicating with the system controller. In this way, the system operator is able to optimize hydrogen production including costs related to production and distribution and thereby ensure best price and availability of the categories of hydrogen requested by consumers, expected to be requested by consumers, possible to produce at a favourable price, etc.

In this way the hydrogen infrastructure facilitates a marketplace for hydrogen where the price of a given category of hydrogen may be determined e.g., by production cost, availability, consumer request and location of the consumer in the infrastructure.

It should be mentioned that the number of members of the infrastructure illustrated in FIG. 2 is not limited to the illustrated numbers. Hence 4, 6, 10 or more electrolysers may be included also electrolysers located in different regions or countries. The same is true for power plants and the mix of power plants which may also count more than what is illustrated.

It should be mentioned that one power plant such as one or more wind turbines may be connected directly to an electrolyser thereby operating as an electric island. This may e.g., be advantageous if the power plant is a photovoltaic plant delivering a DC voltage which then not need to be converted to AC to supply an electrolyser.

The hydrogen infrastructure may include a decentral power plant and electrolyser with associated mobile storage 4 which is not connected to either grid 13 or hydrogen transmission line 3 (not illustrated). This may especially be advantageous in remote areas where the electric infrastructure (i.e., cables) are not well developed. Large wind farms may be erected in such remote areas but if the grid is not able to transit the produced power, then a local electrolyser may use the produced power to production of hydrogen which then may be transported to consumers via mobile storages.

FIG. 3 illustrates an overview of the communication between members of the hydrogen infrastructure according to an embodiment of the invention. In this embodiment, all or most communication is going through the system controller 7 which may be implemented as a cloud computer or as a computer/server located physically at the premises of a system operator. In this embodiment, the communication system include communication between the system controller 7 and controllers 11 of sub-systems SS of the infrastructure, data sources external EDS to the infrastructure and controllers/sensors of members M of the infrastructure. The communication channel therebetween may also be referred to as a central event stream of such central event stream may be part of the communication channel.

The sub-systems SS are understood as systems comprising a local controller 11 capable of controlling the individual member of the infrastructure such as a consumer 5, an electrolyser 1 and a power plant 10/grid operator. The communication with these sub-systems SS is mostly related to capacity, prices, production start/stop, requests, time of delivery, live/real-time or frequent (e.g., every 15 minutes) power production update (source of delivered power), etc. (but of course not limited thereto). The system controller 7 may e.g., request a controller of a grid operator or power plant 10 to a ramp up production of power from a given wind turbine or wind farm. The system controller 7 may e.g., request a controller of an electrolyser 1 to increase or decrease production of hydrogen just to mention two examples of communication between system controller 7 and sub-systems SS.

Hence, locally, at the sub-systems SS, based on received setpoint(s) the controller(s) 11 are operating members of the infrastructure. As an example, the controller of a wind farm may coordinate production of the individual wind turbines of the farm via wind turbine controllers so that the output from the wind farm is as desired/required by the grid operator. In the same way a controller of an electrolyser may be controlling hydrogen production according to setpoints received. As mentioned, setpoints may e.g., be provided by the system controller 7, applied manually to the local controller 11 of the sub-control system or be calculated by the local controller 11 based on the control algorithm implemented therein and received input from associated sub-system SS.

The external data sources EDS are understood as data sources not part of the infrastructure but having indirect impact on the hydrogen production, hydrogen consumption and the like. Examples of external data sources are weather services, natural gas market and grid operators. It is note that the system controller 7 may communicate with a power plant 10 either directly or via the grid operator. Likewise, it is noted that both the grid operator and the system controller 7 may communicate with the same external data source e.g., to receive e.g., a weather forecast that can be used to forecast power production.

In some cases, communication between the system controller and the external data sources is reduced to e.g., a live feed of data related to price of natural gas, prices of electric power, forecast of wind speed, forecast of hours with sun, amount of available power from wind, solar, coal, etc. based power plants, etc. (but of course not limited thereto).

The members M of the infrastructure are understood as the tube trailers i.e., the mobile storage 4, transmission line 3 and the stationary storages 2. Typically, these members M does not comprise a controller (tube trailers may have a controller) but instead sensors for providing information relating to pressure, temperature, mass flow and the like to the system controller.

The sub-systems SS, members M and external data sources EDS facilitates communication channels between the system controller 7 and the sub-systems SS, members M and external data sources EDS. In this way measurements, data and control signals, etc. can be transferred between the sub-systems SS, members M and external data sources EDS and the system controller 7. Preferably the communication channels are wireless connections, for instance based on radio frequency communication, e.g., a proprietary protocol, a low-power Wi-Fi technology, etc, or alternatively the communication channel is wired. The communication channels may also comprise a mix of communication technologies. The dataflow in the communication channels is for most part bidirectional but could also mainly be from e.g., a stationary storage 2 to the system controller 7 such as a continuous or discrete update of a given parameter (such as pressure or temperature).

A communication channel between the system controller 7 and e.g., a weather service or a tube trailer 4 may be setup as a live feed of information provided to the system controller 7. In such communication channel the system controller 7 may have limited possibilities to reply to received information. Accordingly, once set up, data is flowing in the communication channel without actions need to be taken from the sending or receiving end of the information. This type of communication channel can be used for communication between the system controller 7 and many of the sub-systems SS, members M and external data sources EDS.

A communication channel between the system controller 7 and e.g., power plant 10, grid operator and electrolyser may also be setup as a live feed of information provided to the system controller 7. The system controller 7 may process information received from such communication channels and in response to such processing, the system controller 7 may reply with a setpoint relate to production such as increase or decrease production of hydrogen or electric power. Once set up, data may be flowing in the communication channel mainly towards the system controller 7 and in dependency of processing of the data, the system controller may respond and send data the other way. This type of communication channel may be used for communication between the system controller 7 and sub-systems SS and external data sources EDS which thereby may have impact on the category and volume of hydrogen available in the hydrogen infrastructure.

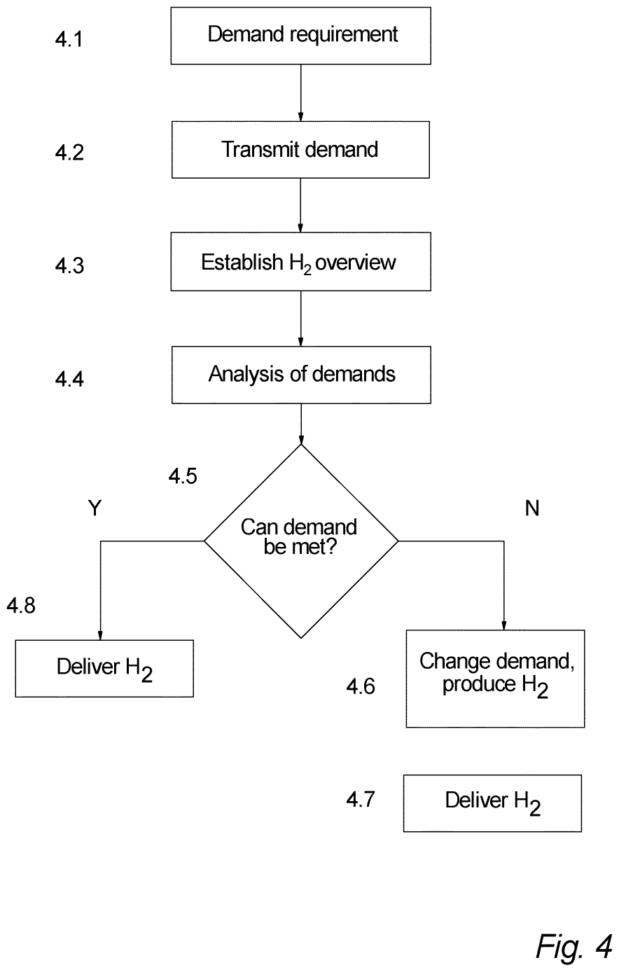

Examples and effects of the processing of the system controller are described below with respect to FIG. 4-6. Note that hydrogen may be produced and distributed in different way than what is described in relation to these figures and that the flows described in relation to these figures may be combined.

A communication channel between the system controller 7 and a consumer 5 may be more advances than mentioned above. First, registration of the consumer 5 is required. The registration may include creating a profile with username and login. The profile and associated information may be stored at the data source DS associated with the system controller 7. The profile may e.g., for the specific consumer provide information to the system controller 7 about billing and possible means of delivering hydrogen (pipeline and/or tube trailer).

Further, the profile may include information regarding contractual aspects such if the consumer rents the trailer for days or weeks as the consumer is using the hydrogen thereof and how much the consumer is charged for such rent. Further, the profile may include information of pricing i.e. if hydrogen is charged according to a fixed amount per volume or a variable price changing e.g. every 10-60 minutes. Further, the profile may include information of long- or short-term price calculation agreement with the consumer. This may include considerations relating to capacity payment, CAPEX (Equipment, Service, Facility and OPEX (Electricity, service, handling costs).

Once the profile is created, the consumer is member of a hydrogen community controlled by the system controller 7. This community of consumer profiles ease handing of requests from consumers by the system controller if a request for a quantity of hydrogen to be delivered or picked up is associated with a consumer profile. Normally, the system controller 7 ensures sufficient hydrogen (of the different categories) in the infrastructure by providing setpoints to the local controllers 11 of the electrolysers 1. However, it should be mentioned, that it may also be possible for the consumers to offer hydrogen for sale among the consumers of the community.

Once a request is established, it is transmitted to and received by the system controller 7 which, based on information received from the above-mentioned communication channels, may be able to respond with a match and deliver hydrogen as requested. Alternative, the system controller is able to establish an offer for a quantity of hydrogen which is at least made available to the consumers of the hydrogen community. The consumes of the community may then react to the offer and reply with an accept, rejection or counteroffer. In this way, the hydrogen offered for sale may be priced according to market forces.

Accordingly, the system controller 7, based on input from the above-mentioned members of the communication system, is able to locate the position and SoC of a tube trailer 4 and receive information of the SoC of a stationary storage 2. Thereby an overview of how much hydrogen the infrastructure comprises and where in the infrastructure this hydrogen is located, if it is movable per se or stored in a stationary storage.

Further, the system controller 7 may be able to predict power production from various power plants based on information e.g. from a weather forecast service, information from a grid operator relating to available power in the grid such as available renewable power generators. Based hereon setpoints for the production of different types of hydrogen at the one or more electrolysers 1 can be made.

Further, the system controller 7 may be able to predict hydrogen consumption in the infrastructure. Such prediction may e.g. be based on historic information of consumption from a data storage, ambient temperature and/or time of the day, day of the week, week of the year, etc. To perform such predictions, the system controller 7 may benefit from consumption made in the past under similar conditions i.e. not necessarily on the same day and in the same place, but under the same circumstances. As an example, the temperature and e.g. traffic density on an October day may be similar to a day in March. Thus, the system controller 7 may establish bins of meta date related to consumption of hydrogen and use the information of theses bins in prediction future consumption and thereby production planning.

Alternatively, or in addition, such prediction may be based on time in terms of individual hour of each week plus holidays. This information may be combined with weather forecasts to predict future consumption.

Further, the invention may utilize machine learning and artificial intelligence for different tasks such as establishing predictions of future hydrogen consumption, when a trailer is full, empty at a certain location, etc. As a non-limiting example, a machine learning algorithm may be trained with actual historic data harvested from the elements of the hydrogen infrastructure system and external elements associated in any way with the hydrogen infrastructure system. In addition to this reference data, the machine learning algorithm may also be trained with structural data such as data relating to distances, travel time, locations, fill time, emptying time, contractual obligations, pricing, personal/users, etc.

The machine learning algorithm may then identify patterns in this reference data. Such patterns may relate to average empty time of a trailer at a certain industrial consumer when a given user is in charge of the operation e.g. including transportation time from electrolyser to consumer during normal operation. This is just to mentioned one specific example of the output of the machine learning algorithm. The machine learning algorithm may be asked for any other relevant estimations by the developer of the algorithm.

Accordingly, since the input data for the machine learning algorithm may be labelled (e.g. as a particular type of data, from a particular data source, etc) the training performed by the machine learning algorithm may be understood as supervised learning. However, note that the invention is not limited to supervised learning, but that it may also, for example, be implemented using reinforcement learning, unsupervised or semi-supervised learning.

Thus, an answer to a question of when a trailer is returning to a mobile filling hub may be established (predicted) automatically, for example via a computer algorithm such as the machine learning algorithm, or it may be established manually, for example via a user interface. Automatic establishment is advantageous since normal/anormal characteristics of multidimensional data may be difficult for humans to analyse. Nevertheless, manual establishment may also be advantageous, since it may permit a user to define constraints according to specific requirements. Embodiments may also combine automatic and manual establishment, for instance an automatic establishment may be provided after a manual establishment is performed. Alternatively, an automatic establishment may be corrected or adjusted by a manual interaction e.g. via user interface.

These few examples are just to illustrate that based on the data flow in the communication channels, the system controller 7 is able to establish various overviews, status, locations, production setpoints, etc. Thereby, the system controller 7 enables a consumer 5 to request a quantity of hydrogen and the system controller 7 to plan production of hydrogen either according to consumer requests, energy price, expected energy price, expected consumption, available storage capacity, etc. Specific examples are provided below especially with respect to FIGS. 4-6. It should be noted that the control of production, storage and distribution of hydrogen according to the present invention may be implemented at a mix of these and other examples.

In addition to the above, the system controller may include at least some kind of adaptive algorithms, artificial intelligence (AI) or machine learning which based on historic usage of the system and trainer dataset related to the individual elements of the infrastructure may assist hydrogen infrastructures may predict future demands, control according to energy consumption optimization (e.g. based on prices, but also other factors as type of energy available, storage, offtake, etc.). Maintenance and fault prediction such as predictive maintenance using AI to analyse data from sensors and infrastructure equipment. This can predict potential failures or maintenance needs, reducing downtime and improving safety. Process optimization which may include AI algorithms continuously analysing production data to optimize various parameters in the hydrogen production process enhancing efficiency and yield. Safety monitoring including monitoring and predicting safety risks by analysing data from sensors detecting leaks, pressure changes, or other hazardous conditions in real-time. Supply chain and logistics optimization, Environmental Impact Analysis. (Carbon footprint, water usage etc.), market price prediction (to decide selling and storing or producing), renewable energy integration including predicting the available renewable energy to optimize the use of green energy, etc.

FIG. 3 further shows that the consumer comprises a consumer user interface 15. The consumer user interface 15 is an interface through which the consumer is able to create a profile and receive information such as available hydrogen (and category thereof), price, time of delivery, etc. The consumer user interface 15 may be implemented as an application associated with the local controller at the consumer end or as a web application. In any case, the consumer user interface 15 may be seen as an entrance to the communication channel between consumer and system controller and the communication therebetween may be structured/defined by the consumer user interface e.g., by only allowing certain type of format, string, etc. of characters to enter the communication channel.

The user interface may be different depending on the user using it. Hence a consumer interface may facilitate specification of an amount hydrogen to be acquired, when it needs to be delivered, how and at which price, etc. If the consumer (or customer) own his own trailer, the price of getting it filled e.g. with or without transportation may be communicated via the user interface. A logistics interface may provide information of location of trailers of a fleet of trailers, which trailers that needs to be filled, which trailers that need to be moved from A to B, etc. A system administrator interface may allow a system administrator to evaluate the different systems, parameters and algorithms, update, service and maintain such systems and algorithms, further develop software, etc. The user interface may be an application for a portable device such as a table or smartphone or a web interface accessible from a laptop.

The consumer 5 may, via the consumer user interface 15, also establish a request for a quantity of hydrogen. The request is defined by request requirements and communicated to the system controller 7. The request requirements available to the consumers may not be the same. Due to the consumer profile, the system controller 7 may be able to differentiate between which request requirements the individual consumer is able to define. This differentiation may either be based on physical constrains at the consumer or restrictions to services available to the individual consumer e.g., in dependency of a subscription/contract associated with the profile. A hydrogen subscription may be made with the system operator.

Alternatively, the system controller 7 may via the consumer user interface present an available quantity of hydrogen (and category and price thereof) to the consumers 5 of the community. The specific quantity presented to the consumer may be selected based on historic information of category of hydrogen consumed in the past by the specific consumer and presented as an offer for sale. The consumer may then respond to this information with a request for further information, suggestions for changes in the offer, accept of the offer, etc.

The communication between the system controller 7 and members of the communication system may be considered communication between the members and a system operator. Accordingly, the system controller 7 may be a controller operated by the operator of the hydrogen infrastructure.

The system operator may own or be in charge of operation of one or more electrolyser 1, transmission line 3 and mobile storage 4. Hence, the system operator is responsible for production and supply/delivery of hydrogen to consumers 5. Accordingly, the system operator communicates with power plant controllers/grid operators and consumers to plan production and delivery of hydrogen according to requests/request requirements and available power in the grid 13.

Based on the communication between members of the communication system, the system controller is able to control and plan production and distribution of hydrogen in the infrastructure. Because of the huge geographical area covered by the infrastructure, storage of hydrogen in the infrastructure is by the system controller planned to be distributed in the infrastructure. In this way, when a batch of hydrogen is offered for sale and a consumer buy at least a quantity thereof, the cost related to deliver this quantity can be reduced if hydrogen is stored closed to the consumer.

FIG. 4 illustrates an embodiment of the invention where hydrogen is distributed and maybe at least partly produced based on a consumer request. The below describe request and communication between local and system controllers may be generic from consumer to consumer. The consumer request can be made via the consumer user interface 15 and communicated to the system controller 7 as described above. Hence, the consumer 5 is part of the hydrogen community and thus initial steps of registration and creation of a profile is not including in the description of FIG. 4.

It should be mentioned that a consumer request may be autogenerated based on an initial set up or the request may be manually generated via the consumer user interface 15.

An automatic generated request is based on request requirements that are specified by a user or person associated with the consumer 5. It may be a simple request that requests hydrogen when a certain minimum SoC is reached in the storage 2, 4 at the consumer.

A manual generated request is established by a user or person associated with the consumer 5 and preferably via the consumer user interface 15. Via the consumer user interface 15, the user is able to select predefined request requirements which together defines the request. The list of predefined request requirements may include, but is not limited to, quantity, price, time of delivery, category, means of delivery (pipeline or tube trailer), etc.

Further, the user may be allowed to give priority to each of the request requirements. The priority then reflects the importance of the different request requirements. So that if time of delivery has a higher priority than price, then the consumer may acquire hydrogen at a higher price than a price specified as a request requirement if a time of delivery specified as a request requirement have to be complied with.

As mentioned, the request requirements options may be defined by the consumer profile such as by a subscription associated with the profile. Thus, the consumer may select between available requirements when defining a request for hydrogen. In embodiments, the consumer may have access to additional request requirements, which may only be available with a premium subscription or by additional purchase.

A simple request may be based on only a requirement to category of hydrogen with no requirements to time of deliver, price, etc. A less simple request may include more of the above-mentioned requirements. Hence, a request requirement typically relates to one parameter and the value of that parameter. As an example, the parameter may be quantity and the value may be 1000 kg. In the following, one example of a request-controlled production and distribution is presented according to one embodiment of the invention.

In a first step 4.1, the consumer selects at least one of a plurality of request requirements i.e., selecting a parameter and if relevant a value for that parameter. In this example the request requirements could be quantity, delivery and hydrogen category. The associated values could be 1500 kg (quantity), mobile (delivery) and green (hydrogen category).

In a second step 4.2, the request established in step 4.1 is transmitted to the system controller 7.

In a third step 4.3, if not already established, the system controller 7 establishes an overview of available hydrogen in the infrastructure. This overview include quantities or batches of hydrogen of different categories, where in the infrastructure this hydrogen is physically located, in which type of storage (mobile or stationary), etc.

In a fourth step 4.4, the system controller 7 analyse or sorts incoming requests e.g., according to a predetermined sorting priority of request requirements. Hence, as example requests are sorted according to quantity, delivery method, time of delivery and category. In this way, the system controller 7 know if the hydrogen infrastructure comprises a quantity of hydrogen matching the total requested quantity.

In a fifth step 4.5, it is evaluated if the infrastructure comprises enough hydrogen to meet the request.

In a sixth step 4.6, if this is not the case the system controller analyses possibilities of changing time of delivery of some of the consumers e.g., in return for a reduced cost of the hydrogen or if hydrogen can be produced in time to comply with the time of delivery.

In a seventh step 4.7, the system controller may acknowledge the request e.g., with an expected time of delivery and subsequently deliver the hydrogen according to the originally received requests or the amended requests agreed with consumer in step 4.6.

In an eight step 4.8, if the infrastructure comprises enough hydrogen to meet the quantity request, the deliver method, the time of delivery and the category of hydrogen, the system controller may acknowledge the request to the consumer e.g., with an expected time of delivery and subsequently deliver the hydrogen accordingly.

The rational of the sorting and analysis algorithm of the system controller carrying out the analyses mentioned in step 4.4 may in an embodiment be as briefly described in the following:

First it is analysed if the requested quantity of a given category can be delivered on time according to the priorities of the consumer request. Hence, if a request gives highest priority to time of delivery, then price and category requirements may not be given any weight or less weight. Likewise, if the request gives highest priority to price of the hydrogen, then time of delivery and category may not be given any weight or less weight. Likewise, if the request gives highest priority to category of the hydrogen, then time of delivery and price may not be given any weight or less weight. And so on.

In the infrastructure does not comprise enough hydrogen as specified in step 4.6, the system controller 7 (or a person associated with the system operator) may communicate with the consumer(s) which cannot have their request complied with. The result of the communication may be a change in time of deliver, price, quantity, etc. Maybe a reduction of quantity in one or more requests may lead to all requests can be complied with. This puzzle is handled by the system controller/system operator.

If despite the communication with the consumers there is not sufficient hydrogen in the infrastructure, then the system controller 7 communicates production orders (operation setpoints) to one or more electrolysers 1. Preferably to electrolysers located physically close to the consumers requesting the hydrogen. A production order could by a quantity of hydrogen of a given category to be produced at a specific point in time. The local controller 11 receiving such production order, then control the electrolyser to comply with the order.

Alternatively, or in addition, the system controller may request hydrogen from an alternative source with is not part of the infrastructure. Such source could be a source able to deliver relevant hydrogen at a competitive price. As an example could be mentioned a hydrogen source operated by an alternative operator such as an electrolyser of a coexisting hydrogen infrastructure. Hence, even though such electrolyser is operated by a competitor, the hydrogen produced here may be competitive or of the needed type so that it may be acquired and transported to an industrial consumer of the “home” hydrogen infrastructure. Especially this situation may occur when an industrial consumer, after a hydrogen production plane is established, requires an amount of hydrogen. Since the production plan are already occupying time slots which are expected to be cheap, this amount of hydrogen is to be produced at a higher cost and thus it will be more expensive. Therefore, it may be relevant to turn to the “global” hydrogen market to see if it is possible for the operator of the hydrogen infrastructure to buy hydrogen from other operators.

In order to be able to comply with varying request requirements of a plurality of requests, the system controller 7 is required to maintain a status of the quantity of each relevant category of hydrogen comprised by the infrastructure. When delivering a requested quantity of hydrogen, this status needs to be updated i.e., a reduction in the particular category of hydrogen is needed. Accordingly, the system controller manage hydrogen storage (mobile and stationary) according to the individual requests or expected future requests to be able to comply with as many requests as possible right away

Subsequent production of hydrogen e.g., of the category just been delivered preferably is initiated.

The system controller may maintain the required status of the quantity of category of hydrogen in the infrastructure based on detailed hydrogen production data on each of batch of hydrogen produced by the electrolysers of the infrastructure. Further, the system controller keeps track on in which storage (stationary or mobile) how much of each batch of hydrogen is stored.

It should be note, that the system controller may be able to manipulate or convert specific volumes of hydrogen comprised by/to be comprised the infrastructure to comply with received consumer requests. In this way green hydrogen may be converter to and sold as e.g. grey hydrogen if this grey hydrogen is needed more that green hydrogen. As an example, one electrolyser is producing hydrogen based on power from a coal power plant and a second electrolyser is producing hydrogen based on power from a wind power plant. If these electrolysers are located far from each other, and a consumer located close by the first electrolyser requests green hydrogen and a consumer located close by the second electrolyser requests brown hydrogen, then the system controller may converter the required amount of hydrogen from both electrolysers and thereby avoid transporting hydrogen over a long distance.

If the request requirement is not detailed with respect to category, the system controller determines the category of hydrogen delivered to comply with that request. Hence, if the trailer used to deliver hydrogen to comply with this request comprise hydrogen produced based on wind power, the hydrogen is green. Even though the consumer request did not specify category, the green hydrogen of that trailer may be used to comply with the consumer request e.g., because it was located close to the consumer. Thus, the system controller digitally converter the 1200 kg hydrogen of that trailer to brown hydrogen and converter 1200 kg of another storage in the infrastructure to green hydrogen. To be able to have such conversion certified may require that the converted amount of hydrogen is within the same geographical area. In the end it may be so, that “converted green hydrogen” may not be certified green hydrogen.

Such conversion is a solely digital conversion made by the system controller having an overview of quantity of hydrogen in the infrastructure (at least a part hereof). Hence, as long as the 1200 kg green hydrogen of that trailer delivered to the consumer is removed from the total amount of green hydrogen of the “entire hydrogen storage” it only “counts once” and the 1200 kg hydrogen of another trailer can be certified green.

It should be mentioned that the system controller may convert e.g. grey hydrogen to green/blue hydrogen e.g. by purchasing Carbon Dioxide quotas/capturing Carbon Dioxide emission. Note that it does not need to be the system administrator that is controlling or performing such purchase/capturing, these services may be provide/acquired from external sources.

In addition to keeping track of the quantity of the different categories of hydrogen in the infrastructure, the system controller also keeps track of location of tube trailers, trucks and the SoC of the tube trailers. In this way, the system controller is able to plan distribution i.e., ensure delivery of a tube trailer at a consumer according to a time of delivery request requirement with the tube trailer closest to the consumer. One example would be that the tube trailer closest to the consumer is delivered to the consumer independent of the category of hydrogen in the trailer and of the request. The system controller is updating the data storage/database storing information of the overall volume of hydrogen by removing or converting the quantity of hydrogen of the trailer, from the category of the request, from the overall volume. Thereby keeping overall volume of the different categories updated.

Such tracking of a tube trailer is possible in that sensors of the tube trailer may be connected to a cloud service through IoT sensors.

Such truck, tube trailer and SoC tracking also include planning which tube trailer should be used e.g., for allowing other tube trailers to be serviced or to wear each trailer of a fleet of trails equally. Also, a truck returning with an empty trailer may be directed to a specific mobile filling hub 6 e.g., based on a production forecast that says a lot of green hydrogen is expected to be produced at an electrolyser fluidly connected to this filling hub.

Planning of routes for a fleet of tube trailers and keeping track of quantities of different categories of hydrogen in the infrastructure may be made by cloud computing, machine learning and/or Artificial Intelligence based principles.

Beside the availability of complying with consumer request, such planning is also relevant to keep the overall costs relating to operating a hydrogen infrastructure low.

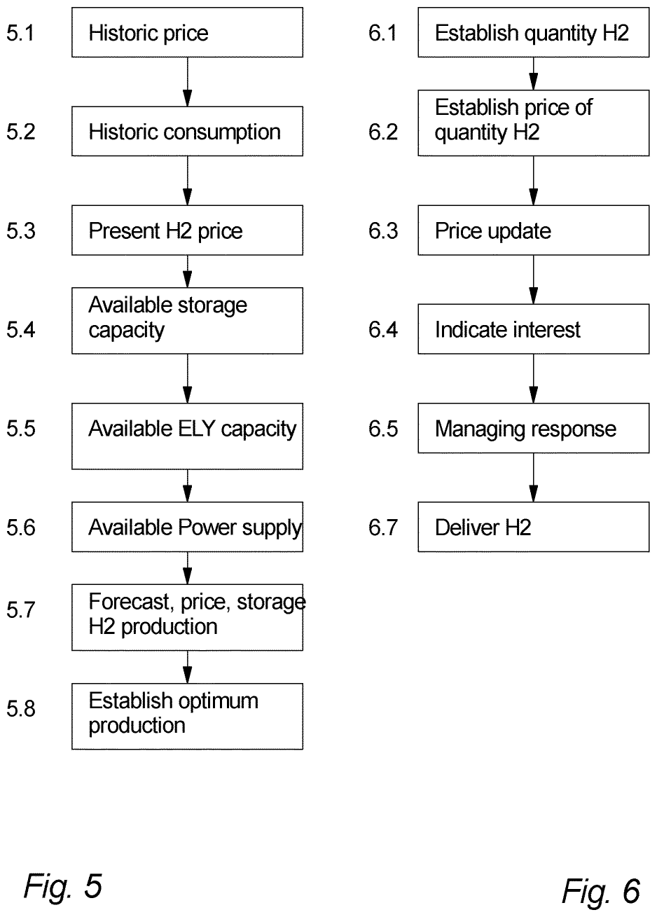

FIG. 5 illustrates a flow chart of the steps of controlling production of hydrogen independent of consumer requests according to an embodiment of the present invention. The focus of a system operator is to produce the hydrogen as cheap as possible and in the categories consumer's request. Therefore, production may in as example be based historic data related to consumption of hydrogen of different categories, historic data relating to price and data related to expected future consumption and/or price.

In a first step 5.1, the system controller establishes historic data relating to production price of various categories of hydrogen. These categories may include green, blue, yellow, pink, grey and/or brown. Such data may be found in a data source DS associated with the system controller.

In a second step 5.2, the system controller establishes historic data relating to consumed hydrogen of the different categories. Such data may also be found in a data source DC associated with the system controller.

In a third step 5.3, the system controller establishes information related to present hydrogen production price. This production price may be either be established by the system controller having knowledge of energy price and operation costs related to one or more electrolysers or from a local controller at the electrolysers.

In a fourth step 5.4, the system controller establishes information related to available storage capacity in the infrastructure i.e., in stationary storage 2, mobile storage 4 or pipelines 3. This SoC of the storages of the infrastructure may be established based on sensor input from the storages.

The information of available capacity may also include information of where a trailer is and when it is expected to return empty or partly empty from a consumer. It should be mentioned that consumers may be obligated to return a trailer at a certain point in time and with a certain SoC, thus this kind of information may be established by knowledge of contract between system operator and consumer and/or based on sensor input from the tube trailer (such as temperature, pressure and GPS signal)

In a fifth step 5.5, the system controller may establish information of available capacity in electrolysers. Information relating to load of an electrolyser may be provided by the local controller of such electrolyser. Further, this information may also include information of a permanent or temporary maximum capacity which may not be the same e.g., due to service of parts of the electrolyser/electrolyser plant. This information can be used determine if it is possible to increase production if the price/available type of power is present.

In a sixth step 5.6, the system controller may establish information of available capacity in power plants. Wind turbines may for some reasons be derated i.e., producing less power than their nominal power. The delta power between current production and nominal production may be used as input to determination of a possible increase of production of e.g., green hydrogen. This type of information is typically provided from or by a power plant controller or a wind turbine controller. Such delta power may also be available from other power plants that wind turbines.

Further, it may also be the other way round. If the system operator/controller according to a hydrogen production plan is stopping production of hydrogen this may be communicated to the grid operator for him to take actions and prepare a reduction of power produced e.g. from wind turbines to avoid too large grid disturbances if megawatt electrolyser plants more or less instantly shuts down.

On the other hand, if the grid operator have such available power it may be advantageous to continue production of hydrogen for stock instead of shutting down part of a wind farm.

Power from wind turbines is just used as an example. It is the available power in the electric grid or off-grid solutions as such or locally related to an electrolyser that is interesting i.e., also from photovoltaic, water, coal, etc. systems.

In a seventh step 5.7, the system controller establishes forecasts of energy price, hydrogen production price, storage capacity in the infrastructure, production capacity of electrolysers, etc. such forecasts can be made e.g., from historic data available on data sources DS, input from weather services, grid operators, etc.

In an eights step 5.8, the system controller establishes the optimum hydrogen production conditions based on the information established in the previous 7 steps. The production may be optimized according to hydrogen category, hydrogen production price, storage capability in the network, etc. In this way it may be ensured that available hydrogen meets consumer requests and/or as much as possible of the hydrogen (e.g., of a particular category) is produced as cheap as possible.

The data and information established above may not need to be established or achieved in the order presented above and not all information may be available or updated to determine when to produce hydrogen. With this said, the more information available, the easier it may be to choose the most optimum time/price to produce hydrogen.

It should be mentioned that determination of the optimum time of production of hydrogen (e.g., relating to price, category, etc.) may also include information of requests or expected requests of specific category of hydrogen.

Hydrogen can be offered for sale by the system operator in batches or quantities which may be defined by category. This way of distributing hydrogen in the infrastructure is from a starting point independent of consumer requests. With this said quantities defined based on knowledge of pending consumer requests may be offered for sale in the infrastructure.

In a first step 6.1, quantities of hydrogen already produced and stored e.g., in a stationary or mobile storage or in a pipeline are established. Such quantity of hydrogen may be defined e.g., as a mix of green and brown hydrogen in a 80/20 relationship, as a 100% green quantity or the like. This is possible as described above due to the information established by the system controller from the members of the infrastructure/communication system.

In a second step 6.2, a price of the different quantities of hydrogen is established by the system controller. The price of these quantities of hydrogen obviously depends on the cost of the power supplied to the electrolyser when the hydrogen was produced. This actual production price may not be the same as a real-time production cost, if the same hydrogen should have been produced at a later point in time (e.g., real-time i.e., at the time it is offered for sale to consumes).

Therefore, the quantities may be offered for sale to members of the hydrogen community at different prices e.g., reflecting the actual production costs or the real-time production costs. It should be mentioned that the quantities of hydrogen may also be offered for sale to consumers not member of the hydrogen community, but to a higher price.

In a third step 6.3, the price of the quantities is updated by the system controller. The update frequency may follow the update frequency of prices of the electric power on the electric energy market. Examples of updated frequency is every 5, 10, 15, 20 or 30 minutes or higher.

In a fourth step 6.4, consumers may indicate if a certain quantity is of interest. Such indication may be in the form of an accept of the price at with a given quantity of hydrogen is for sale or by placing a counterbid. Alternatively, the consumer may indicate that the hydrogen is not relevant either by doing nothing or rejecting the price.

In a fifth step 6.5, the system controller is managing the responses to the quantity of hydrogen offered for sale.

If only one consumer accepts, the consumer is notified, and the hydrogen is delivered according to the terms and conditions associated with the offer. Such terms and conditions could be delivered in a tube trailer, which must be returned in 7 days from delivery, or similar.

If no consumers are accepting the offer of a particular quantity, the system controller lowers the price of that particular quantity. The price may then be reduced to a price lower than the actual and real-time production price.

If more than one consumer accepts, the system controller is determining which of the consumers that should have the particular quantity. The system controller may select the consumer that accepted first, that placed a higher counter-bit, that has a premium subscription to the community or the like. The counter-bit may increase flexibility e.g., in terms of delivery with respect to time of delivery, method of delivery, etc.

In a sixth step 6.6, the system controller notifies the selected consumer and if not in place, start planning delivery of the specific quantity to the consumer e.g., according to initial or updated terms of delivery.

It should be noted, that the hydrogen production setpoint may be updated every 5, 10 or 15 minute according to energy price marked i.e. a production setpoint may be updated with the same speed as the prices of the energy marked. In this way, hydrogen production can be continuously optimized according to price and category.

Further, the system controller may analyse e.g., historic hydrogen production cost data and real-time/current energy prices. If such analysis indicates that hydrogen e.g., of a specific category has been sold to a price that is higher than what can be produced with the current energy price, then, a production setpoint is transmitted to the local controller of the electrolyser to start/increase production. Such production start/increase may be transmitted even if no consumer requests are made as long as the infrastructure has storage capacity to the produced hydrogen.

No matter if the hydrogen is produced based on requests from a consumer or a batch of hydrogen is offered for sale and consumers can request a quantity of that batch, a plurality of requests may be received within a time period. The time period may be limited if it is the system operator that offers a batch of hydrogen for sale.

Requests received within the same time period may be referred to as real-time requests. They may be sorted by the system controller according to request requirements such as price, means of delivery, quantity, etc.

The system controller may distribute hydrogen to consumers according to different approaches including “hydrogen for all”, “hydrogen for highest price”, “hydrogen of specific colour”, “hydrogen of a specific batch size”, “hydrogen for optimized cost”, “hydrogen for VIP (VIP; Very Important Person) consumers”, etc. A VIP consumer may be defined by the amount of hydrogen the consumer is acquiring is expected to acquire or is committed to acquire in the future. This may be relevant if the infrastructure does not comprise hydrogen enough to meet all requests or the infrastructure does not comprise enough available tube trailers to meet all requested time of delivery.

The hydrogen for all approach ensures that that all requests are at least partly acknowledge and each consumer thereby receives at least part of the requested quantity. It may not by the requested category or quantity, but hydrogen is received. The system controller may according to this approach divide the volume of hydrogen that is available and possible to deliver equally between the consumers. Notify the consumers and deliver.

The hydrogen for highest price approach ensures that requested quantity of hydrogen is delivered to the consumer willing to pay the highest price. The system controller may according to this approach sort the requests with respect to price and start form the top by acknowledge the request and deliver hydrogen according to the sorted list of requests.

From the above it is now clear that the invention relates to a system and method of producing and distributing hydrogen in a hydrogen infrastructure. The hydrogen is distributed according to requests provided by consumers. The requests are handled/analysed by a system controller which based on requirements of the request and knowledge of where in the infrastructure hydrogen is stored/will be produced and stored, is establishing a hydrogen delivery package including a hydrogen batch matching the consumer and distributing hydrogen to consumers according to the requests. If the request from the consumer allows sufficient flexibility e.g. in type of the requested hydrogen and time of delivery, the request and hydrogen deliver package is rematched for the benefit of the consumer in terms of price to the hydrogen deliver package and for the benefit of the infrastructure manager in terms of capacity utilization of electrolyser, storage, and logistics. The optimal capacity utilization has the advantage of cheaper hydrogen and/or higher quantity of available hydrogen.

The rematch is preferably event based i.e. triggered by a change in energy price, unexpected change in infrastructure element (such as an error in trailer, electrolyser, etc), additional consumer requests and the like. Hence, the same batch of hydrogen may be requested by several consumers, or the same batch of hydrogen (available or future available) may be offered for sale by the system controller to all consumers of the system.

Further production of hydrogen is optimized according to available storage in the infrastructure i.e., by an electrolyser close to an empty storage, according to price and type of power supplied to an electrolyser, etc.

The invention has been exemplified above with the purpose of illustration rather than limitation with reference to specific examples of the present invention. Details such as a specific method and system structures have been provided in order to understand embodiments of the invention. Note that detailed descriptions of well-known systems, devices, circuits, and methods have been omitted so as to not obscure the description of the invention with unnecessary details.

### LIST

1. Electrolyser
2. Stationary hydrogen storage
3. Hydrogen transmission line
4. Mobile hydrogen storage
5. Industrial consumer
6. Mobile hydrogen storage connection
7. System controller
8. Gas supply line
9. Gas burner, such as a variable gas burner
10. Power plant
11. Local controller
12. Mobil filling hub
13. Electrical Grid
14. Vehicle
15. Consumer user interface
SS. Sub-system
EDS. External data source
M. Member of infrastructure
DS. Data storage

1.-59. (canceled)

60. A system configured to allocate and distribute hydrogen in a hydrogen infrastructure system, wherein said hydrogen infrastructure system comprises a plurality of infrastructure members including:
an electrolyser configured for producing hydrogen,
a stationary hydrogen storage,
a plurality of mobile hydrogen storage, and
a plurality of industrial consumers,
wherein a system controller is configured for receiving data from at least part of said infrastructure members and based on said received data, said system controller is configured for:
manage quantity of currently available hydrogen of said hydrogen infrastructure system and of future available hydrogen in said hydrogen infrastructure system,
allow a plurality of industrial consumers to request a quantity of hydrogen wherein said request include at least one request requirement,
matching a request requirement from a request from a particular industrial consumer with any combination of said currently available hydrogen and said future available hydrogen, and
if a match can be established facilitate delivery of said requested quantity of hydrogen to said particular industrial costumer.

61. The system according to claim 60, wherein said system controller is configured for transmitting a start production of hydrogen setpoint to said electrolyser prior to receiving said request.

62. The system according to claim 60, wherein said system controller is configured to categorize said produce hydrogen in batches, wherein a batch of hydrogen is defined as a quantity of hydrogen produced based on a particular type of power or as a quantity of hydrogen produced during a particular period of time.

63. The system according to claim 60, wherein a batch is defined after the hydrogen comprised by the batch is produced.

64. The system according to claim 60, wherein said batch of hydrogen is a mix of currently available hydrogen and future available hydrogen.

65. The system according to claim 60, wherein said system controller is configured for determining a color of said quantity of hydrogen of said produced hydrogen according to the type of power supplied to said electrolyser during production of said quantity of hydrogen and wherein hydrogen in at least one of said batches is a mix of hydrogen quantities having different colors.

66. The system according to claim 60, wherein said system controller is configured for sorting a plurality of said requests according to said request requirements.

67. A method of distributing hydrogen in a hydrogen infrastructure system comprising:
an electrolyser for production of hydrogen,
a stationary hydrogen storage,
a plurality of mobile hydrogen storage,
a plurality of distributed industrial consumers comprising a consumer user interface and a local controller, and
a system controller,
wherein at least one of said distributed industrial consumers:
via said consumer user interface and said local controller establish a request for hydrogen defined by at least one request requirement, wherein said at least one request requirement specifies at least quantity of requested hydrogen and time of delivery of said hydrogen and
wherein said request is transmitted to said system controller,
wherein said system controller is matching said request with any combination of current available hydrogen and future available hydrogen, wherein said future available hydrogen is available in time for delivery to said distributed industrial consumer within said time of delivery, and
wherein said system controller is performing a continuous re-matching of said request with current available hydrogen and future available hydrogen to determine the most cost-efficient combination of hydrogen which is complying with said request.

68. The method according to claim 67, wherein said quantity of produced hydrogen is produced for storage in a particular mobile hydrogen storage or stationary hydrogen storage.

69. The method according to claim 67, wherein said system controller categorize said produced hydrogen in batches and attach batch information to said hydrogen batch, wherein said batch information is updated at least once before reaching its final destination.

70. The method according to claim 67, wherein said system controller divides one or more produced batches of hydrogen into two or more requested quantities.

71. The method according to claim 67, wherein said request is associated with a consumer profile of a hydrogen community.

72. The method according to claim 67, wherein said request comprises one or more request requirements.

73. The method according to claim 67, wherein said power supply information comprise information identifying the power plant producing power to said electrolyser producing said quantity of requested hydrogen.

74. The method according to claim 67, wherein said system controller convert at least part of said quantity of hydrogen from one type of hydrogen to another type of hydrogen.

75. The method according to claim 67, wherein said match between said request requirement and said batch of hydrogen is subsequently updated.

76. The method according to claim 67, wherein said system |controller is establishing at least one hydrogen production setpoint based on said request requirements, wherein said at least one hydrogen production setpoint is communicated from said system controller to a local controller of said electrolyser, wherein said local controller starts production of hydrogen when said at least one hydrogen production setpoint is complied with.

77. The method according to claim 67, wherein said match is performed by said system controller by identifying said at least one request requirement and compare said at least one request requirement with a corresponding hydrogen production data associated with hydrogen stored in said stationary hydrogen storage or in said mobile hydrogen storage.

78. The method according to claim 67, wherein said system controller establishes an alternative hydrogen quantity if hydrogen stored in said stationary hydrogen storage or in said mobile hydrogen storage does not match said at least one request requirement.

79. The method according to claim 67, wherein said system controller establish a certificated of said quantity of hydrogen and track wherein said hydrogen infrastructure said quantity of hydrogen is.
